(19) United States
(12) Patent Application Publication
(10) Pub. No.: US 2026/0291557 A1
(43) Pub. Date: Sep. 24, 2026

(54) PRECODER CONFIGURATION FOR MULTI-ANTENNA PORT TRANSMISSION

(71) Applicant: Telefonaktiebolaget LM Ericsson (publ), Stockholm (SE)

(72) Inventors: Robert Mark HARRISON, Grapevine, TX (US); Chandan PRADHAN, Yokohama, Kanagawa (JP); Sven JACOBSSON, Västra Frölunda (SE)

(73) Assignee: Telefonaktiebolaget LM Ericsson (publ), Stockholm (SE)

(21) Appl. No.: 19/472,713

(22) PCT Filed: Apr. 5, 2024
(86) PCT No.: PCT/EP2024/059348

§ 371 Date: Oct. 6, 2025

Related U.S. Application Data
(60) Provisional application No. 63/458,062, filed on Apr. 7, 2023.

(51) Int. Cl. H04B 7/0456; H04B 7/06

(52) U.S. Cl. CPC H04B 7/0456; H04B 7/0639

(57) ABSTRACT

A wireless device having N antenna ports, with N>4, receives (s1202), signaling configuring the wireless device to transmit according to a set of precoders, the set of precoders comprising a first type of precoder and a second type of precoder. For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset. Further, the wireless device receives (s1204) an indication that identifies a precoder of the first or the second type. Further, the wireless device transmits (s1206) signals on the antenna ports according to the identified precoder.

### TECHNICAL FIELD

The present disclosure relates to methods for transmission and reception using multiple antenna ports and to corresponding devices, systems, and computer programs.

### BACKGROUND

Wireless communication networks have been widely deployed and have dramatically increased in technical sophistication. Concomitantly, performance metrics such as bandwidth, capacity, throughput, latency, etc., continue to improve. The Third Generation Partnership Project (3GPP) is an organization that develops and promulgates technical standards governing the structure and operation of wireless networks. 3GPP publishes these standards in a series of numbered releases (e.g., Rel-15, Rel-18, etc.). The technical standards are divided into generations. First generation (1G) networks were analog; 2G introduced digital communications; and 3G provided higher data rates, enabling the transmission of multimedia content such as video and music. 4G networks, also known as Long Term Evolution (LTE), are deployed worldwide. 4G facilitates high-bandwidth applications such as video streaming and online gaming. 5G networks, also known as New Radio (NR), are in development and early stages of deployment. 5G addresses multiple disparate use cases, such as Enhanced Mobile Broadband (eMBB) for video streaming, virtual and augmented reality, and cloud gaming; Ultra-Reliable Low-Latency Communications (URLLC) for autonomous vehicles and remote surgery; Massive Machine Type Communications (MTC) to support massive numbers of low-power, low-bandwidth devices; Smart Cities, supporting a range of municipal applications such as traffic management, public safety, and energy management; and the like.

A key technical feature of advanced wireless communication networks is Multiple Input Multiple Output (MIMO) technology, which uses multiple antennas at both the transmitter and receiver to increase the capacity of the network, by exploiting multiple paths in the wireless channel between a transmitter and receiver. The rank, or number of layers, of a MIMO system refers to the number of independent data streams that can be transmitted simultaneously, and it is determined by the number of transmit and receive antennas. Precoding is a signal processing technique used to condition signals to be transmitted, to optimize their Signal to Noise Ratio (SNR) at the receiver, based on channel conditions determined by receiving Reference Signals (RS) from the other device immediately prior to the MIMO transmission.

In the time domain, NR Downlink (DL) and Uplink (UL) transmissions are organized into equally sized subframes of 1 ms each. A subframe is further divided into multiple slots of equal duration. The slot length depends on subcarrier spacing. For 15 kHz subcarrier spacing, there is only one slot per subframe. In general, for 15·2^{μ} kHz subcarrier spacing, where μ∈{0,1,2,3,4}, there are 2^{μ} slots per subframe. Finally, each slot consists of 14 symbols (unless extended cyclic prefix is configured).

In the frequency domain, a system bandwidth is divided into Resource Blocks (RBs) each corresponding to 12 contiguous subcarriers. One subcarrier during one symbol interval forms one Resource Element (RE).

### UL Transmission/Precoding Schemes

The physical channel that carries data in the NR UL is called the Physical Uplink Shared Channel (PUSCH). In NR, there are two variations of Orthogonal Frequency Division Multiplexing (OFDM) that can be used for PUSCH: Cyclic Prefix OFDM (CP-OFDM) and Discrete Fourier Transform Spread OFDM (DFT-S-OFDM). Also, there are two transmission schemes specified for PUSCH: Codebook (CB) based precoding and Non-Codebook (NCB) based precoding.

The base station, referred to in 5G as gNB, configures, in Radio Resource Control (RRC) signaling, the transmission scheme through the higher-layer parameter txConfig in the PUSCH-Config Information Element (IE). CB-based transmission can be used for non-calibrated User Equipment (UEs) and/or for Frequency Division Duplexing (FDD) (i.e., UL/DL reciprocity does not need to hold). NCB-based transmission, on the other hand, relies on UL/DL reciprocity and is, hence, intended for Time Division Duplexing (TDD).

### CB-Based Precoding

CB-based PUSCH is enabled if the higher-layer parameter txConfig is set to ‘codebook’. For dynamically scheduled PUSCH with configured grant type 2, CB-based PUSCH transmission can be summarized in the following steps:

1. The UE transmits a Sounding Reference Signal (SRS), configured in an SRS resource set with higher-layer parameter usage in SRS-Config IE set to ‘codebook’. Up to two SRS resources (for testing up to two virtualizations/beams/panels) each with up to four ports, can be configured in the SRS resource set.

2. The gNB determines the number of layers (or rank) and a preferred precoder (i.e., Transmit Precoding Matrix Indicator, or TPMI) from a codebook subset based on the received SRS from one of the SRS resources. The codebook subset is configured via the higher-layer parameter codebookSubset, based on reported UE capability, and is one of
fully coherent (‘fullyAndPartialAndNonCoherent’), or
partially coherent (‘partialAndNonCoherent’), or
non-coherent (‘nonCoherent’),
   where coherence refers to controlling phase across all MIMO antenna ports.

3. If two SRS resources are configured in the SRS resource set, the gNB indicates the selected SRS resource via a 1-bit SRI field in the Downlink Control Information (DCI) scheduling the PUSCH transmission. If only one SRS resource is configured in the SRS resource set, the SRI field is not indicated in DCI.

4. The gNB indicates, via DCI, the number of layers and the TPMI. Demodulation Reference signal (DM-RS) port(s) associated with the layer(s) are also indicated in DCI. The number of bits in DCI used for indicating the number of layers (if transform precoding is enabled, the number of PUSCH layers is limited to 1) and the TPMI is determined as follows (unless UL full-power transmission is configured, for which the number of bits may be different):
4, 5, or 6 bits if the number of antenna ports is 4, if transform precoding is disabled, and if the higher-layer parameter maxRank in PUSCH-Config IE is set to 2, 3, or 4 (see Table 1).
2, 4, or 5 bits if the number of antenna ports is 4, if transform precoding is disabled or enabled, and if the higher-layer parameter maxRank in PUSCH-Config IE is set to 1 (see Table 2).
2 or 4 bits if the number of antenna ports is 2, if transform precoding is disabled, and if the higher-layer parameter maxRank in PUSCH-Config IE is set to 2 (see Table 3).
1 or 3 bits if the number of antenna ports is 2, if transform precoding is disabled or enabled, and if the higher-layer parameter maxRank in PUSCH-Config IE is set to 1 (see Table 4).
0 bits if 1 antenna port is used for PUSCH transmission.

5. The UE performs PUSCH transmission over the antenna ports corresponding to the SRS ports in the indicated SRS resource.

FIG. 1A shows a table with precoding information and number of layers, for 4 antenna ports, if transform precoding is disabled and maxRank=2, 3 or, 4 (in accordance with Table 7.3.1.1.2-2 of 3GPP TS 38.212, e.g. V17.5.0 (2023 March)). FIG. 1B shows precoding information and number of layers, for 4 antenna ports, if transform precoding is disabled/enabled and maxRank=1 (in accordance with Table 7.3.1.1.2-3 of 3GPP TS 38.212, e.g. V17.5.0 (2023 March)). FIG. 1C shows precoding information and number of layers, for 2 antenna ports, if transform precoding is disabled and maxRank=2 (in accordance with Table 7.3.1.1.2-4 of 3GPP TS 38.212, e.g. V17.5.0 (2023 March)). FIG. 1D shows precoding information and number of layers, for 2 antenna ports, if transform precoding is disabled/enabled and maxRank=1 (in accordance with Table 7.3.1.1.2-5 of 3GPP TS 38.212, e.g. V17.5.0 (2023 March)).

For a given number of layers, the TPMI field indicates a precoding matrix that UE should use for PUSCH. In a first example, if the number of antenna ports is 4, the number of layers is 1, and transform precoding is disabled then the set of possible precoding matrices is shown in FIG. 2A, which shows a precoding matrix, W, for single-layer transmission using four antenna ports when transform precoding is disabled (in accordance with Table 6.3.1.5-3 of 3GPP TS 38.211, e.g. V17.4.0 (2022 December)). FIG. 2B shows a precoding matrix, W, for four-layer transmission using four antenna ports when transform precoding is disabled (in accordance with Table 6.3.1.5-7 of 3GPP TS 38.211, e.g. V17.4.0 (2022 December)).

How fully-, partially-, and non-coherent transmission is facilitated in Rel-15 codebook-based transmission can be understood through the example precoding matrices above. Each column of a matrix contains a set of scale factors to be used to transmit a MIMO layer, and each row of a given column contains the scale factor to be applied to a particular antenna port for that layer. If a given scale factor is zero, then the UE should not transmit the MIMO layer on the antenna port. On the other hand, if at least two scale factors in a column are non-zero, they will combine together for a given layer, and the UE must transmit with mutually controlled phase among these antenna ports. If each column of a precoding matrix contains only one non-zero scale factor, the UE may transmit non-coherently, i.e., without mutually controlled phase. Examples of such non-coherent precoding matrices are those with TPMI indices 0-3 in FIG. 2A and with TPMI index 0 in FIG. 2B. By contrast, if each column of a precoding matrix contains only non-zero scale factors, the UE must transmit with mutually controlled phase on all antenna ports, and so uses fully coherent transmission. Examples of fully coherent precoding matrices include with TPMIs 12-27 in FIGS. 2A and 3 and 4 in FIG. 2B. Finally, if each column of a precoding matrix contains some non-zero and some zero scale factors, the UE may transmit partial-coherently, with mutually controlled phase required only among subsets of the antenna ports. Examples of partial coherent precoding matrices include with TPMIs 4-11 in FIGS. 2A and 1 and 2 in FIG. 2B. It is important to also observe here that partial coherent precoding is not possible for 2 Tx operation, since with two port transmission either all or none of the ports are transmitted together in a coherent way. This need to consider partial coherent operation complicates the design of 4 Tx UL MIMO schemes.

UEs that can maintain phase among antenna ports can generally transmit also without controlled phase. The converse where UEs that can transmit without controlled phase can be assumed to be able to also transmit with control phase is generally not true. Since transmitting without controlled phase is enabled through the use of zero-valued scale factors in Rel-15 non-coherent or partially coherent precoding matrices, these precoders may be used to select which antenna ports to transmit upon. When the antennas corresponding to the antenna ports are directive, such selection can pick directions that the UE should transmit, and so these precoders can have better performance in some channel conditions than the fully coherent precoders (provided sufficient power is available for the antennas). Furthermore, transmitting on a subset of antenna ports can allow the UE to transmit with reduced total power. These two behaviors then can motivate the codebook designs described above, where precoding matrices with different coherence requirements are included in a codebook. Fully coherent UEs can support all three types of precoders, and so can support codebook subsets labeled as ‘fullyAndPartialAndNonCoherent’, while partially coherent UEs can support non-coherent but not fully coherent precoders, and so can support ‘partialAndNonCoherent’ codebook subsets. Lastly, non-coherent UEs only support the ‘nonCoherent’ precoders and codebook subset. This combination of precoders with different coherence types in a codebook or codebook subset may be referred to as ‘nesting’ the precoders.

### UL Full Power Mode in Rel-16

### UE PA Implementations

From a UE Power Amplifier (PA) implementation point of view the Rel-15 power scaling specification may have benefits since it limits the required output power per PA at the UE. For example, for a 4 port UE, regardless of rank, coherence capability, and precoder selection, the power-scaling scheme makes sure that a maximum of Pcmax/4 is required from respective PA (assuming one PA per antenna port at the UE). This makes it cheaper to implement the UE, since low power PAs are cheaper than high power PAs. However, if a 4-port UE is equipped with one or more PAs with higher output power than Pcmax/4, then Rel-15 power scaling will limit the potential of utilizing the extra output power. To handle this, it was agreed in Rel-16 that three different UE PA architectures (referred to as capabilities, even though it is not strictly ‘capabilities’ and may not directly indicate maximum PA power on each of the UE's Tx chains) should be considered when specifying the Rel-16 power scaling modes, as illustrated schematically in FIG. 3. For Capability 1, all PAs (Tx chains) at the UE should be able to transmit with the maximum allowed output power Pcmax, for Capability 2, none of the PAs can transmit at Pcmax, and for Capability 3, a subset of the PAs can transmit with Pcmax. Note that the PAs not being able to transmit with Pcmax, can transmit with any output power below Pcmax. Release 15 power scaling was mainly designed for Capability 2 UEs.

Three different uplink full power transmission (UL FPTx) modes have been specified in Rel-16, Mode 0, Mode 1, and Mode 2. Mode 1 is intended to support full power transmission for non-coherent and partially coherent UEs with PA ‘Capability 2’ and ‘Capability 3’. In Mode 1, the power scaling scheme is unchanged (i.e., the same power scaling as specified in Rel-15 is used), and full power transmission is instead achieved by adding fully coherent precoders (for respective rank) to the non-coherent and partially coherent codebooks. Since the Rel-15 power scaling factor (ρ/ρ0) for fully coherent precoders is unity (=1), the UE will transmit these precoders with full output power.

An example of a 2 Tx non-coherent Mode 1 UE is shown in FIG. 4. Since here the UE transmits with rank 1 precoder [1 1], it will transmit on both of its Tx chains, and both are half power, the UE transmits the full 23 dBm.

One problem with Mode 1 (and in general any UE implementation that transparently virtualize antenna ports to combine Tx chains' power) is that the fully coherent precoders will combine UL signals from UE Tx chains (antenna ports) that do not have controlled phase coherency. This implies that the transmitted signals when added up at the receiving antennas may combine either constructively or destructively depending on the uncontrolled phase difference between the UE Tx chains (during the time of PUSCH transmission), the channel and the applied precoder. This unpredictable behavior will make it difficult for the Transmission and Reception Point (TRP) to determine the modulation and coding scheme (MCS) and rank for the UL transmission, leading to deteriorated UL performance.

One way to mitigate this problem is to introduce a relative delay, also called cyclic diversity delay (CDD), between the antenna ports during UL transmission. This use of CDD shown in FIG. 4 with the delay unit Z^{-N}. The delay results in a relative phase between the antennas that increases linearly with frequency. If the bandwidth times of the transmission is sufficiently large given the delay, the relative phase will sweep over all possible values, averaging over both the constructive and destructive combinations, and the power of the received signal will be the sum of the power of the signal transmitted on both Tx chains through the channel to each antenna.

In general, the UE can apply a delay for each antenna port of kδ where k is the port index and δ is some delay that is small enough to be transparent to the gNB and not significantly degrade channel estimation. The UE will then use the same delay when transmitting the SRS ports as when transmitting PUSCH. The gNB can then sum the channel estimates from each of the SRS to match the effective channel of the PUSCH transmitted with a [1 1] precoder, thereby obtaining accurate Channel Quality Information (CQI) and rank estimates when the bandwidth and delay are sufficiently large. If the PUSCH bandwidth is too small for CDD to cycle the precoders adequately and the antenna patterns overlap, since the SRS relative phase is not controlled and may be different from the relative phase of the PUSCH, the CQI and rank estimates may be inaccurate when the gNB synthesizes the composite channel from the SRS ports.

The following fully coherent precoders have been added to the Rel-15 codebooks for Mode 1 operation. Note that in the 4 Tx case, since UEs capable of partially coherent operation can support non-coherent operation, the rank 2 precoder with TPMI 6 and the rank 3 precoder for non-coherent operation can be used by partially coherent UEs. Therefore, it was not necessary to define rank 2 or 3 precoders specifically for partially coherent operation. It is important to note that while ‘fully coherent’ precoders are used in Mode 1, again, the UE is not required to maintain coherence among the antenna ports, and so such a UE can transmit without controlled phase on at least a subset of its antenna ports and Tx chains. FIG. 5A shows a configuration for 2 TX non-coherent UEs, FIG. 5B shows a configuration for 4 TX non-coherent UEs, and FIG. 5C shows a configuration for 4 TX partially coherent UEs with Rank 1.

### Agreements in Rel-18 Related to 8 Tx UE

In NR Rel-18, support for 8 Tx UEs will be specified. As part of this it has been agreed that two types of partially coherent UEs will be supported, one with two antenna groups (with four antennas per antenna group), and one with four antenna groups (with two antennas per antenna group). It has also been agreed that the antennas within one antenna group are assumed to be mutually coherent, and antennas belonging to different antenna groups are assumed not to be mutually coherent. FIG. 6 illustrates an example of a UE with 4 antenna groups, and where each antenna group consists of two antenna elements with mutually orthogonal polarizations.

There currently exist certain challenge(s). Rel-15 4 Tx UL MIMO allows UEs to save power by indicating precoders that transmit on a subset of transmission chains. Precoders corresponding to transmission on 1, 2, 3, or 4 Tx chains using fully, partial, and non-coherent transmission are always present in UEs that support fully coherent transmission, in other words, partial- and non-coherent precoders are ‘nested’ in codebooks with fully coherent precoders. For 8 Tx transmission in Rel-18, the possible number of precoders that correspond to partially coherent transmission is generally quite large. Therefore, using the Rel-15 principle of nesting partial and non-coherent with fully coherent precoders may still save power, but can require excessively large codebooks and DCI overhead.

### SUMMARY

Certain aspects of the disclosure and their embodiments may provide solutions to these or other challenges. For 8 Tx, nesting partially—with fully-coherent precoders in codebooks does not tend to improve performance over fully-coherent only codebooks in some important antenna configurations. Therefore, some codebook designs herein do not nest partially-coherent precoders together with fully-coherent precoders.

While they also do not tend to improve system capacity or coverage in some important antenna configurations, because non-coherent precoders allow UEs to transmit on a subset of their Tx chains, they can enable power savings. Therefore, some designs herein nest non-coherent with fully-coherent precoders.

The lack of capacity gains from non-coherent precoders can be found even when all combinations and subsets of the ports in an antenna array are transmitted upon. Especially when UEs have Tx chains that have most or all the same maximum power capability PAs, saving power only requires that a certain number, rather than a particular set, of Tx chains is active. This means that very few non-coherent precoders may need to be nested with fully-coherent precoders to enable power saving. Therefore, in some embodiments, there is only one precoder for each rank of non-coherent transmission, i.e., there are at most 8 non-coherent precoders. Such precoders may be described for rank L using diagonal matrices with ones on the first L diagonal elements and zeroes on the remaining elements.

While they tend to require more precoders than non-coherent precoders, partially-coherent precoders can provide better performance for some antenna configurations. Since fully-coherent UEs are capable of transmitting coherently among subsets as well as all of their antenna elements, some codebook designs herein also nest partially—with fully-coherent precoders. It is important to limit the size of such nested codebooks, and so designs are provided where codebooks only transmit on subsets of the antenna ports in the UE's antenna array or use a minimal number of phase differences among antenna ports, or both.

According to an embodiment, a method is provided. The method is performed by a wireless device operative in a wireless communication network and having N antenna ports, wherein N>4. The method comprises receiving, from the wireless communication network, signaling configuring the wireless device to transmit according to a set of precoders, the set of precoders comprising a first type of precoder and a second type of precoder. For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset. Further, the method comprises receiving, from the wireless communication network, an indication that identifies a precoder of the first or the second type. Further, the method comprises transmitting signals on the antenna ports according to the identified precoder.

According to a further embodiment, a method is provided. The method is performed by a wireless device operative in a wireless communication network and having N antenna ports. The method comprises receiving signaling configuring the wireless device to transmit according to a set of precoders, the set comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, the method comprises receiving an indication from the wireless communication network identifying a precoder of the first or the second type. Further, the method comprises transmitting signals on antenna ports according to the identified precoder.

According to a further embodiment, a method is provided. The method is performed by a network node operative in a wireless communication network. The method comprises sending, to a wireless device having N antenna ports, wherein N>4, signaling configuring the wireless device to transmit according to a set of precoders. The set of precoders comprises a first type of precoder and a second type of precoder. For a transmission comprising L layers, the first type of precoder corresponds to the wireless device transmitting on all of the N antenna ports with mutually controlled phase among all the ports, and the second type of precoder corresponds to the wireless device transmitting on at least a subset of the N antenna ports and to transmitting without controlled phase among all the antenna ports in the subset. Further, the method comprises sending, to the wireless device, an indication that identifies a precoder of the first or the second type. Further, the method comprises receiving, from the wireless device, signals transmitted on the antenna ports according to the identified precoder.

According to a further embodiment, a method is provided. The method is performed by a network node operative in a wireless communication network. The method comprises sending, to a wireless device having N antenna ports, signaling configuring the wireless device to transmit according to a set of precoders, the set comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, the method comprises sending, to the wireless device, an indication identifying a precoder of the first or the second type. Further, the method comprises receiving, from the wireless device, signals transmitted by the wireless device on antenna ports according to the identified precoder.

According to a further embodiment, a wireless device for operation in a wireless communication network is provided. The wireless device has N antenna ports, wherein N>4. The wireless device is configured to receive, from the wireless communication network, signaling configuring the wireless device to transmit according to a set of precoders, the set of precoders comprising a first type of precoder and a second type of precoder. For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset. Further, the wireless device is configured to receive, from the wireless communication network, an indication that identifies a precoder of the first or the second type. Further, the wireless device is configured to transmit signals on the antenna ports according to the identified precoder.

According to a further embodiment, a wireless device for operation in a wireless communication network is provided. The wireless device has N antenna ports, wherein N>4. The wireless device comprises processing circuitry and a memory storing instructions to be executed by the processing circuitry, whereby execution of the instructions causes the wireless device to receive, from the wireless communication network, signaling configuring the wireless device to transmit according to a set of precoders, the set of precoders comprising a first type of precoder and a second type of precoder. For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset. Further, execution of the instructions causes the wireless device to receive, from the wireless communication network, an indication that identifies a precoder of the first or the second type. Further, execution of the instructions causes the wireless device to transmit signals on the antenna ports according to the identified precoder.

According to a further embodiment, a wireless device for operation in a wireless communication network is provided. The wireless device has N antenna ports. The wireless device is configured to receive signaling configuring the wireless device to transmit according to a set of precoders, the set comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, the wireless device is configured to receive an indication from the wireless communication network identifying a precoder of the first or the second type. Further, the wireless device is configured to transmit signals on antenna ports according to the identified precoder.

According to a further embodiment, a wireless device for operation in a wireless communication network is provided. The wireless device has N antenna ports. The wireless device comprises processing circuitry and a memory storing instructions to be executed by the processing circuitry, whereby execution of the instructions causes the wireless device to receive signaling configuring the wireless device to transmit according to a set of precoders, the set comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, execution of the instructions causes the wireless device to receive an indication from the wireless communication network identifying a precoder of the first or the second type. Further, execution of the instructions causes the wireless device to transmit signals on antenna ports according to the identified precoder.

According to a further embodiment, a network node for operation in a wireless communication network is provided. The network node is configured to send, to a wireless device having N antenna ports, wherein N>4, signaling configuring the wireless device to transmit according to a set of precoders. The set of precoders comprises a first type of precoder and a second type of precoder. For a transmission comprising L layers, the first type of precoder corresponds to the wireless device transmitting on all of the N antenna ports with mutually controlled phase among all the ports, and the second type of precoder corresponds to the wireless device transmitting on at least a subset of the N antenna ports and to transmitting without controlled phase among all the antenna ports in the subset. Further, the network node is configured to send, to the wireless device, an indication that identifies a precoder of the first or the second type. Further, the network node is configured to receive, from the wireless device, signals transmitted on the antenna ports according to the identified precoder.

According to a further embodiment, a network node for operation in a wireless communication network is provided. The network node comprises processing and a memory storing instructions to be executed by the processing circuitry, whereby execution of the instructions causes the network node to send, to a wireless device having N antenna ports, wherein N>4, signaling configuring the wireless device to transmit according to a set of precoders. The set of precoders comprises a first type of precoder and a second type of precoder. For a transmission comprising L layers, the first type of precoder corresponds to the wireless device transmitting on all of the N antenna ports with mutually controlled phase among all the ports, and the second type of precoder corresponds to the wireless device transmitting on at least a subset of the N antenna ports and to transmitting without controlled phase among all the antenna ports in the subset. Further, execution of the instructions causes the network node to send, to the wireless device, an indication that identifies a precoder of the first or the second type. Further, execution of the instructions causes the network node to receive, from the wireless device, signals transmitted on the antenna ports according to the identified precoder.

According to a further embodiment, a network node for operation in a wireless communication network is provided. The network node is configured to send, to a wireless device having N antenna ports, signaling configuring the wireless device to transmit according to a set of precoders, the set comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, the network node is configured to send, to the wireless device, an indication identifying a precoder of the first or the second type. Further, the network node is configured to receive, from the wireless device, signals transmitted by the wireless device on antenna ports according to the identified precoder.

According to a further embodiment, a network node for operation in a wireless communication network is provided. The network node comprises processing and a memory storing instructions to be executed by the processing circuitry, whereby execution of the instructions causes the network node to send, to a wireless device having N antenna ports, signaling configuring the wireless device to transmit according to a set of precoders, the set comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, execution of the instructions causes the network node to send, to the wireless device, an indication identifying a precoder of the first or the second type. Further, execution of the instructions causes the network node to receive, from the wireless device, signals transmitted by the wireless device on antenna ports according to the identified precoder.

According to a further embodiment, a computer program or computer program product is provided, e.g., in the form of a non-transitory, computer readable medium. The computer program or computer program product comprises computer-executable instructions that, when executed by processing circuitry of a wireless device having N antenna ports, wherein N>4, configure the wireless device to receive, from the wireless communication network, signaling configuring the wireless device to transmit according to a set of precoders, the set of precoders comprising a first type of precoder and a second type of precoder. For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset. Further, the instructions, when executed by the processing circuitry, configure the wireless device to receive, from the wireless communication network, an indication that identifies a precoder of the first or the second type. Further, the instructions, when executed by the processing circuitry, configure the wireless device to transmit signals on the antenna ports according to the identified precoder.

According to a further embodiment, a computer program or computer program product is provided, e.g., in the form of a non-transitory, computer readable medium. The computer program or computer program product comprises computer-executable instructions that, when executed by processing circuitry of a wireless device having N antenna ports, configure the wireless device to receive, from the wireless communication network, signaling configuring the wireless device to transmit according to a set of precoders, the set of precoders comprising a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, the instructions, when executed by the processing circuitry, configure the wireless device to receive, from the wireless communication network, an indication that identifies a precoder of the first or the second type. Further, the instructions, when executed by the processing circuitry, configure the wireless device to transmit signals on the antenna ports according to the identified precoder.

According to a further embodiment, a computer program or computer program product is provided, e.g., in the form of a non-transitory, computer readable medium. The computer program or computer program product comprises computer-executable instructions that, when executed by processing circuitry of a network node, configure the network node to send, to a wireless device having N antenna ports, wherein N>4, signaling configuring the wireless device to transmit according to a set of precoders. The set of precoders comprises a first type of precoder and a second type of precoder. For a transmission comprising L layers, the first type of precoder corresponds to the wireless device transmitting on all of the N antenna ports with mutually controlled phase among all the ports, and the second type of precoder corresponds to the wireless device transmitting on at least a subset of the N antenna ports and to transmitting without controlled phase among all the antenna ports in the subset. Further, the instructions, when executed by the processing circuitry, configure the network node to send, to the wireless device, an indication that identifies a precoder of the first or the second type. Further, the instructions, when executed by the processing circuitry, configure the network node to receive, from the wireless device, signals transmitted on the antenna ports according to the identified precoder.

According to a further embodiment, a computer program or computer program product is provided, e.g., in the form of a non-transitory, computer readable medium. The computer program or computer program product comprises computer-executable instructions that, when executed by processing circuitry of a network node, configure the network node to send, to a wireless device having N antenna ports, signaling configuring the wireless device to transmit according to a set of precoders. The set of precoders comprises a first type of precoder and a second type of precoder. For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting on antenna ports of different groups, under at least one of the following constraints: the precoders in the second type of precoders transmit on a total number of antenna ports fewer than N, and the precoders in the second type of precoders transmit with a phase difference between antenna ports within a group of either 0 or 180 degrees. Further, the instructions, when executed by the processing circuitry, configure the network node to send, to the wireless device, an indication that identifies a precoder of the first or the second type. Further, the instructions, when executed by the processing circuitry, configure the network node to receive, from the wireless device, signals transmitted on the antenna ports according to the identified precoder.

In some embodiments, support for full power transmission on a single antenna port with a non-coherent precoder can be indicated. In related embodiments, support for full power transmission on a subset of antenna ports using a set of partially-coherent precoders can be indicated. This allows the UE to turn off all or a subset of its 8 PAs except one, while transmitting at full power. Transmitting all power on one or a subset of PAs rather than splitting among more PAs is more efficient, since power efficiency drops with the number of active power amplifiers.

Certain embodiments may provide one or more of the following technical advantage(s). Embodiments herein enable 8 Tx MIMO UEs that are capable of fully coherent transmission to save power by transmitting on a subset of their Tx chains. This is supported with little or no increase in DCI overhead, but the indication to transmit on the subset can be for any given slot, i.e., fully dynamic.

Embodiments that nest only fully coherent and non-coherent precoders together can support power saving operation as well as where fully coherent UEs may not be able to transmit coherently at particular points in time, such as where SRS is not transmitted close enough in time to PUSCH.

Details of such embodiments and further embodiments will be apparent from the following detailed description of embodiments.

### BRIEF DESCRIPTION OF THE DRAWINGS

FIGS. 1A-1D illustrate examples of precoding information for transmissions using multiple antenna ports of a UE.

FIGS. 2A and 2B illustrate example of precoding matrices.

FIG. 3 schematically illustrates multi-antenna transmission capabilities of a UE.

FIG. 4 illustrates a non-coherent transmission mode of a UE.

FIGS. 5A, 5B, and 5C schematically illustrate examples of multi-antenna port transmit configurations of a UE.

FIG. 6 shows an example of a UE having multiple antenna groups.

FIG. 7 shows an example of power efficiency of transmissions by a UE.

FIG. 8 shows an example of structures of a UE having 8 power amplifiers.

FIG. 9 shows a table for illustrating examples of power amplifier architecture of a UE.

FIG. 10 shows a table with possible codebook size for 8 Tx fully-coherent precoder candidates.

FIG. 11 shows a table with possible codebook size for 8 Tx non-coherent precoder candidates.

FIG. 12 shows a flowchart for schematically illustrating a method according to an embodiment of the invention.

FIG. 13 shows a flowchart for schematically illustrating a further method according to an embodiment of the invention.

FIG. 14 shows a flowchart for schematically illustrating a further method according to an embodiment of the invention.

FIG. 15 shows a flowchart for schematically illustrating a further method according to an embodiment of the invention.

FIG. 16 schematically illustrates a communication system according to an embodiment of the invention.

FIG. 17 schematically illustrates a UE according to an embodiment of the invention.

FIG. 18 schematically illustrates a network node according to an embodiment of the invention.

FIG. 19 schematically illustrates a host according to an embodiment of the invention.

FIG. 20 schematically illustrates a virtualization environment according to an embodiment of the invention.

FIG. 21 schematically illustrates communication between a host computing system, a network node, and a UE via multiple connections, at least one of which is wireless, according to an embodiment of the invention.

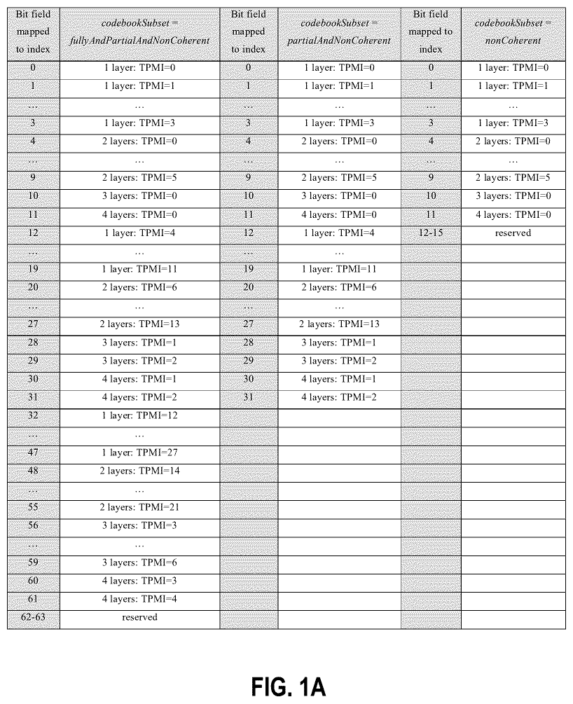

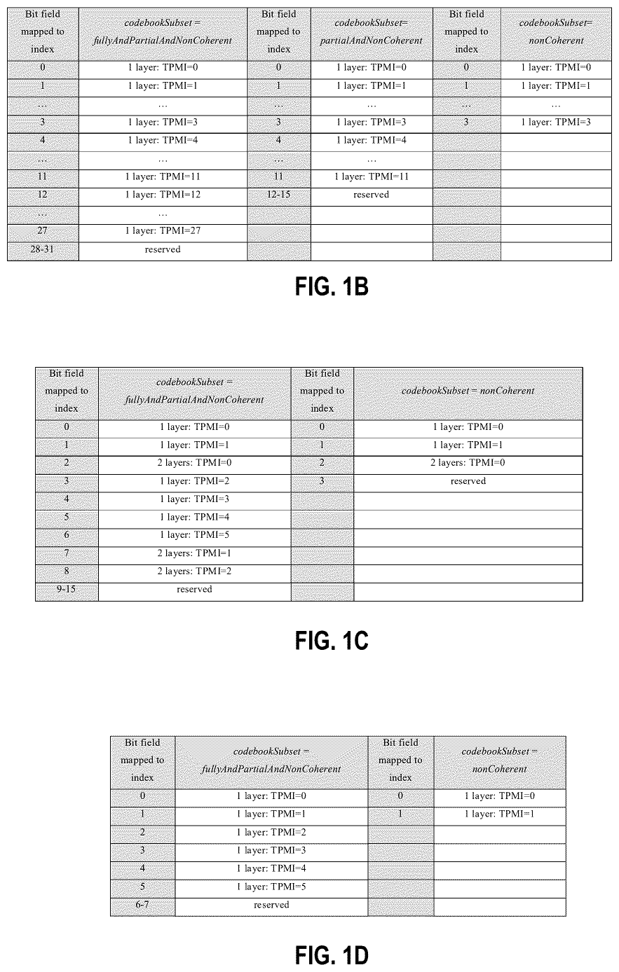

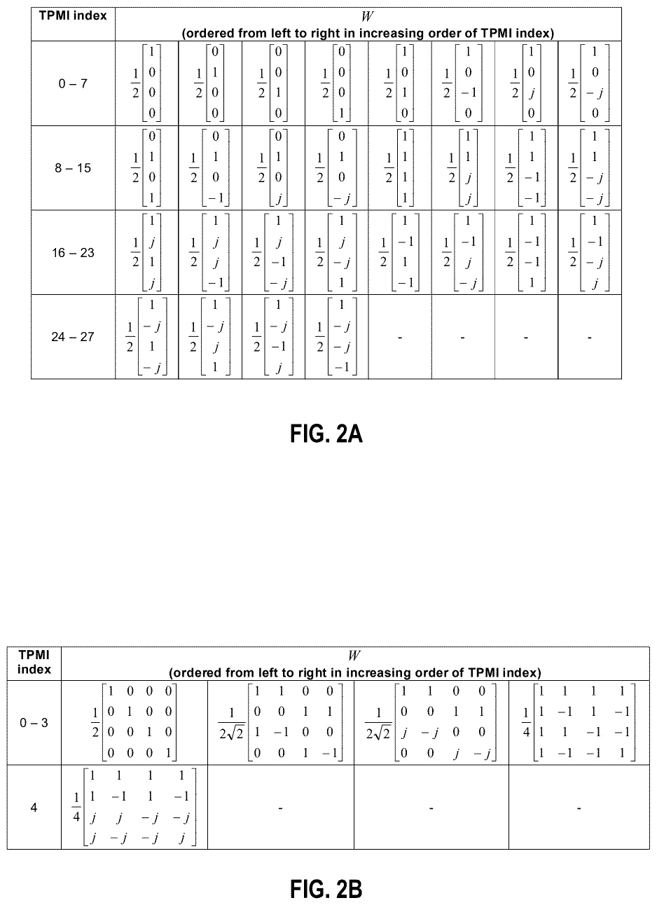

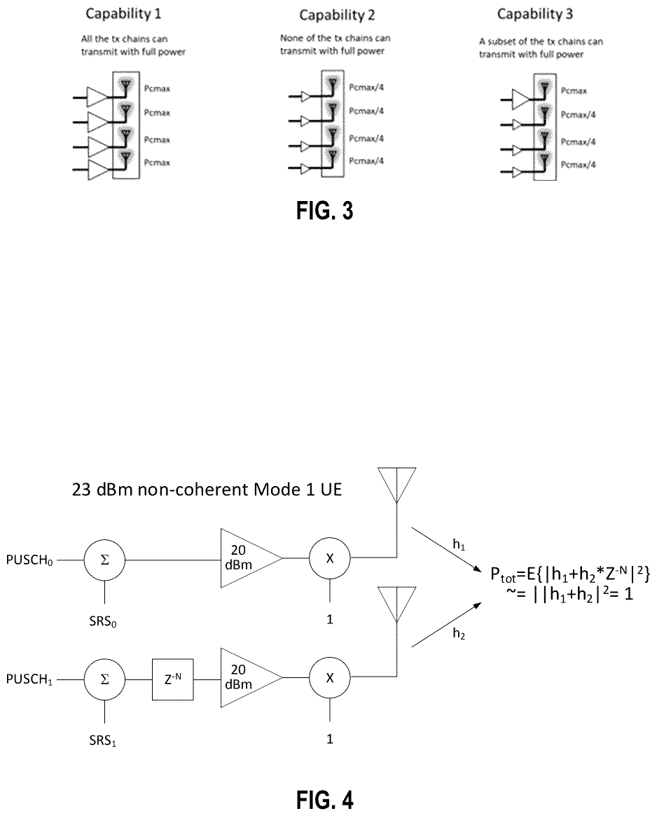

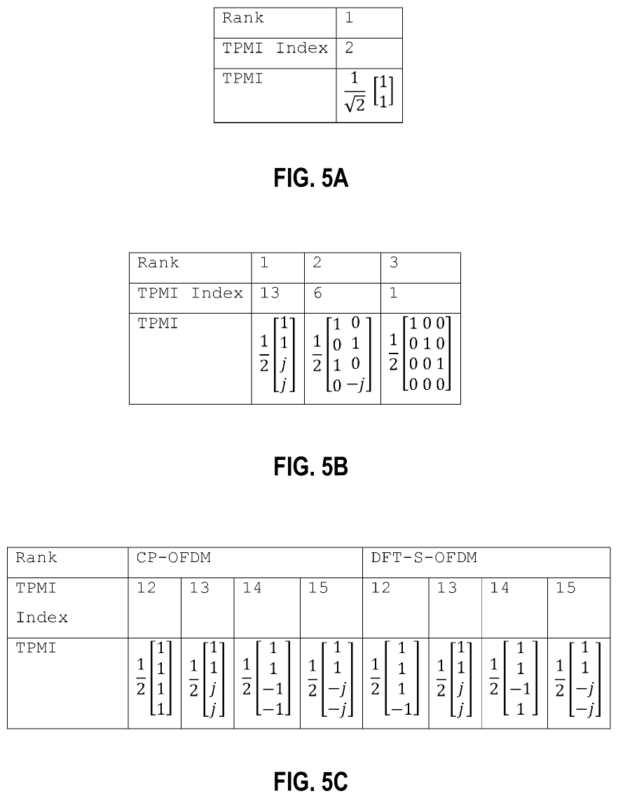

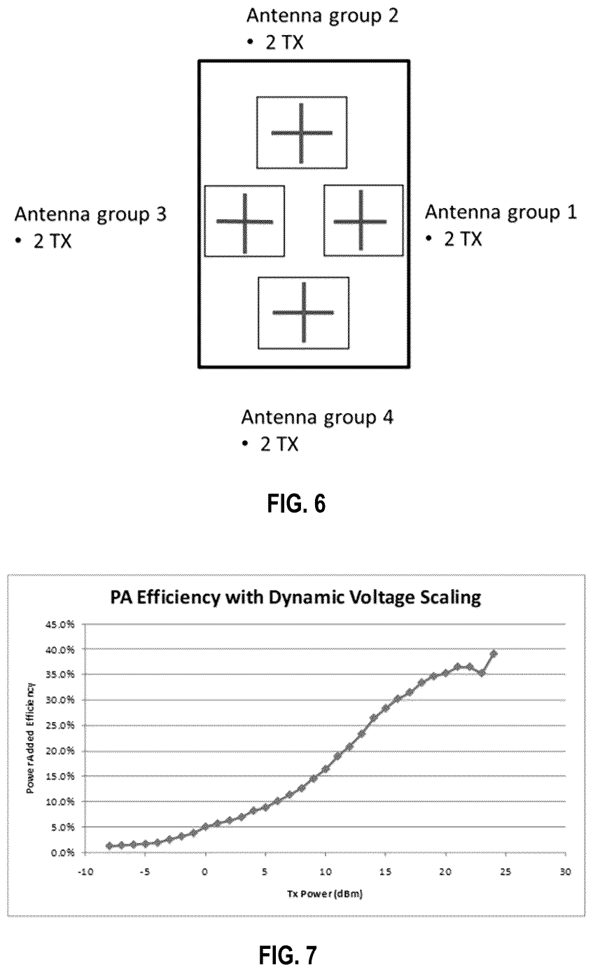

### DETAILED DESCRIPTION

Some of the embodiments contemplated herein will now be described more fully with reference to the accompanying drawings. Embodiments are provided by way of example to convey the scope of the subject matter to those skilled in the art.

### Power Saving Codebooks for 8 Tx UL MIMO UEs

UE power amplifiers tend to have higher power efficiency when transmitting at higher power levels. This is illustrated by FIG. 7, reproduced from 3GPP technical report 25.863, “Uplink transmit diversity for High Speed Packet Access (HSPA)”, rev. 11.0, where the power added efficiency of a UE PA is given as a function of the transmit power. As can be seen, transmitting at a higher power tends to result in greater efficiency. This means that transmitting with a power P on one PA is more efficient than transmitting at a power P/N on N PAs. For example, if a UE with this PA were to transmit at 20 dBm on one PA, it could reach 35% efficiency. If it were to transmit on 8 PAs at 11 dBm, it would reach roughly 20% efficiency, 15% less than the single PA case. We observe that as the number of PAs increases, the power per PA then decreases, and so larger arrays tend to be more greatly impacted by the loss in PA efficiency with decreasing power. Therefore, the importance of being able to turn off PAs for power efficiency is greater in the 3GPP Rel-18 case where 8 PAs are needed as compared to earlier releases with at most 4 PAs.

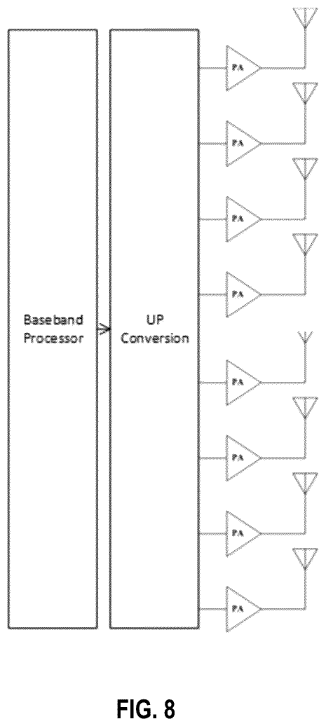

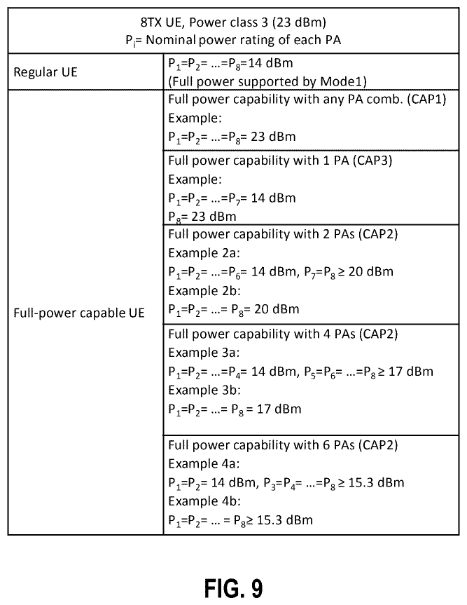

FIG. 8 schematically illustrates structures of a UE having 8 PAs, e.g., to be used for 8 Tx UL MIMO operation. FIG. 9 shows a table with exemplary power configurations of the PAs when assuming that the UE is Power Class 3 (i.e., has a total transmit power of 23 dBm).

### Oversampling Ratio and Antenna Configuration Combinations

For designs based on the Type 1 DL codebook, an open question is the oversampling ratios (OSRs), i.e., the values of (O₁, O₂) that should be supported per (N₁, N₂), where O₁ and O₂ denote values of the OSR for antenna port numbers N1 and N2, respectively. For evaluation purpose of codebook alternatives when a precoder based on Rel-15 DL Type I is used, following oversampling ratios may be assumed: (O₁, O₂)=(1,1), (2,1), (2,2).

When using simulations to compare the performance of OSR (1, 1), (2, 1), and (4, 1) in a Type-I DL codebook for an 8-port fully-coherent cross-polarized 1×4 ULA (Uniform Linear Array) in an outdoor FWA (Fixed Wireless Access) scenario, it can be seen that there is almost no difference between the OSRs. This is predictable, since while there is less loss at the beam crossover points, and hence increased average antenna gain of higher OSRs, this is not likely to improve system throughput in such a high SNR scenario, especially if SU-MIMO scheduling is assumed in the simulation. When assuming an “indoor FWA” scenario, it can be seen that the relative performance of the OSR is a little more discernible, where the OSR=1 case can be seen to have slightly worse performance than the higher oversampling ratios. Such observations point to a potential benefit of simpler codebooks with OSR as low as 1, e.g., for a UE equipped with a 1×4 dual polarized ULA.

Rel-15 codebooks include elements that are powers of j, which can be maintained with sufficiently low OSRs. Such designs simplify UE precoding implementation. Since designs using such low OSRs perform well enough for the considered scenarios, this feature of Rel-15 codebooks could be retained for 8 Tx.

In view of the above, it may be beneficial to restrict codebooks for 8 TX UEs such that elements of the precoding matrices are limited to the set {+1, +j, −1, −j}. This implies that (O₁, O₂)=(1,1) for N_{g}=1 and (N₁, N₂)=(4, 1), and that (O₁, O₂)=(2, 2) for Ng=1 and (N₁, N₂)=(2, 2).

Further, for fully coherent uplink precoding by an 8TX UE, based on NR Rel-15 single panel DL Type I codebook (CodebookMode=1), it may be considered whether/how to support (O₁, O₂)=(2,1), (2,2), whether for all ranks, or for rank 1-2, or for rank 3-8.

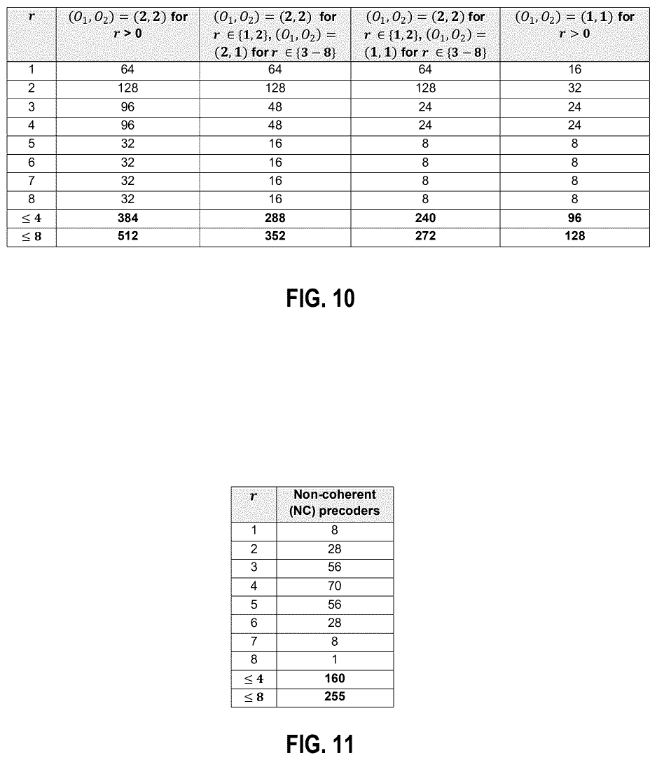

The DCI overhead for signaling the fully-coherent (FC) codebooks with (N₁, N₂)=(2, 2) depends on the oversampling (O₁, O₂). A possible reduced oversampling factor as a function of transmission rank may be considered. The codebook size for the FC precoders with (N₁, N₂)=(2,2) for different values of (O₁, O₂) as a function of the transmission rank is summarized in the table of FIG. 10.

When using simulations to evaluate the above alternatives for the FC precoders, it can be observed that all the FC design options have a similar performance except when the FC precoders are restricted to have (O₁, O₂)=(1,1) for r>0, which have a visible loss in the performance, especially at the cell-edge. Hence, the codebook size of the FC precoders for (N₁, N₂)=(2,2) can be reduced with a reduction in (O₁, O₂) for higher ranks with a minimal performance loss. Accordingly, reducing the oversampling factors (O₁, O₂) to (1,1) for rank 3-8, while having (O₁, O₂)=(2,2) for rank 1 and 2, may reduce the codebook size significantly without any noticeable loss in the performance.

### Non-Coherent Precoder Design

For non-coherent (NC) uplink precoding by an 8TX UE, following precoders are supported for 1 layer transmission.

$$[ \begin{matrix}1 \\ 0 \\ 0 \\ 0 \\ 0 \\ 0 \\ 0 \\ 0\end{matrix} ] , [ \begin{matrix}0 \\ 1 \\ 0 \\ 0 \\ 0 \\ 0 \\ 0 \\ 0\end{matrix} ] , [ \begin{matrix}0 \\ 0 \\ 1 \\ 0 \\ 0 \\ 0 \\ 0 \\ 0\end{matrix} ] , [ \begin{matrix}0 \\ 0 \\ 0 \\ 1 \\ 0 \\ 0 \\ 0 \\ 0\end{matrix} ] , [ \begin{matrix}0 \\ 0 \\ 0 \\ 0 \\ 1 \\ 0 \\ 0 \\ 0\end{matrix} ] , [ \begin{matrix}0 \\ 0 \\ 0 \\ 0 \\ 0 \\ 1 \\ 0 \\ 0\end{matrix} ] , [ \begin{matrix}0 \\ 0 \\ 0 \\ 0 \\ 0 \\ 0 \\ 1 \\ 0\end{matrix} ] , [ \begin{matrix}0 \\ 0 \\ 0 \\ 0 \\ 0 \\ 0 \\ 0 \\ 1\end{matrix} ]$$

with the scaling factor of

$$\frac{1}{2 \sqrt{2}} .$$

The NC codebooks can be designed by selecting all the precoder matrices obtained by choosing r ports out of 8 ports, where r is the transmission rank. The number of candidates for the NC precoders is given in the table of FIG. 11.

The above NC codebook design requires at most 8 bits of signaling overhead, when N_{g}=8. However, all the 255 NC candidates may not be required to obtain an acceptable performance, which can provide an opportunity to reduce the overhead for signaling the NC precoders. When using simulations to compare the performance of two NC codebook designs with 255 and 32 candidates of NC precoders, respectively, assuming that the antenna ports are arranged as four dual polarized antenna ports pointing in four different directions and the 32 candidates are a subset of 255 the candidates, which include the 8 NC precoders for rank 1, it can be seen that there is a negligible loss in the performance by bringing down the number of NC precoders from 255 to 32. At the same time, the signaling overhead of NC precoders can be reduced from 8 bits to 5 bits. The overhead to signal NC codebooks can therefore be brought down to 5 bits from 8 bits with a negligible loss in the performance.

### Nesting Non-Coherent (NC) Precoders and Fully-Coherent (FC) Precoders

One of the principles of the Rel-15 UL MIMO design is the nesting of different coherence precoders. For Rel-18 8Tx UE, it would in principle be possible to reuse the legacy codebook subset configuration rule, where, a UE reporting its UE capability of ‘partialAndNonCoherent’ transmission cannot be configured with ‘fullyAndPartialAndNonCoherent’ and a UE reporting its UE capability of ‘nonCoherent’ transmission cannot be configured with ‘fullyAndPartialAndNonCoherent’ or with ‘partialAndNonCoherent’.

Nesting precoders can significantly increase signaling overhead, and so the tradeoffs of this overhead vs. the benefits of nesting need to be taken in account in the design. Using nesting can allow the following:
Power saving: Power saving was a key motivation for including the NC precoders in Rel-15, and also for including the selection vectors in the Rel-10 LTE MIMO codebook. Since power amplifiers tend to operate more efficiently at higher power, transmitting on a single PA rather than two half power PAs tends to be significantly more efficient. Since other components supporting a Tx chain also consume power, the savings from turning off a Tx chain can be greater than only those from turning off a PA.
Coherence fall back: 3GPP Rel-15 specifications require that SRS be transmitted within 20 ms of PUSCH for the UE to maintain coherence among its antenna ports. The network may switch among higher and lower coherence precoding as the need for higher array gain increases or decreases with SINR variation. In these cases, SRS can be triggered and FC precoding used when the precoding gain is needed, while SRS is not transmitted when NC precoding (including multi-layer transmission) is sufficient.
Support for directional antennas: UE designs are by their nature much more varied, as well as more limited, than gNBs, and so it is crucial that the UL MIMO designs do not simply replicate DL MIMO. 8 Tx UE antenna arrays may not be simple, planar pairs of cross-polarized elements, for example in FWA applications where different panels point in different directions. FC precoders combine the antenna patterns of array elements, which may not be desirable if the patterns/beams do not overlap, as this can increase interference to a non-serving node and can reduce array gain. This increase in interference can strongly affect system throughput.
Enhanced performance from diversity gain in full power UL MIMO: In fading, a given antenna element can be stronger than others, and so allowing partial- or non-coherent precoders to be selected as well as fully-coherent precoders can improve UL performance. However, if each element of an N element can only carry 1/N of the power, the benefit of this diversity gain can be lost. This means that nesting lower coherence precoders can be more beneficial if full power UL MIMO is supported. Since 8 Tx uses more antenna elements, the diversity gain from nesting partial- or non-coherent precoders with fully-coherent precoders may be less beneficial than for 2 or 4 Tx.

Nesting precoders with different coherence can thus enable UE power saving, coherence fall back for infrequent SRS, and support for directional UE antennas. However, the performance gain of nesting may need to be considered. There seems to be a benefit of supporting some kind of coherence nesting in 8 Tx UL MIMO. However, 8 Tx codebooks are much larger than Rel-15 2 or 4 Tx codebooks, and so simply nesting full-, partial-, and non-coherent precoders together into one large nested codebook may cause excessive TPMI overhead.

While turning off all but one PA would naturally maximize efficiency, it also minimizes the gain from UL MIMO, since UL MIMO by its nature requires multi-antenna transmission. Perhaps the simplest way to obtain UL MIMO transmission is to non-coherently transmit a single layer on each of L antenna elements for a rank L transmission. An N antenna element array would require a total of N non-coherent precoders in this case, and so is a quite compact codebook. For a rank L transmission in an N element array, the power savings will grow as L/N decreases. Therefore, if the codebook design supports non-coherent transmission with rank 1≤L<N, the full flexibility of power savings from turning off various elements of the array can be obtained.

If a reduced granularity of power savings is desired, a smaller set of non-coherent precoders could be used. For example, non-coherent precoders for ranks 1, 2, 4, and 8 could be used, which allow the maximum power saving but the worst MIMO performance with 1 port transmission, the nearest to maximum power saving with 2 ports and improved MIMO performance, a middle value of power saving and MIMO performance with 4 ports, and no power saving but the highest MIMO performance (for a non-coherent codebook) with 8 ports.

The most basic case where only one non-coherent precoder with only one active antenna port is used would then allow maximum power saving, but no support for rank >1 with non-coherent transmission. Such a design could be suitable where the UE always has the best performance from, and can operate with, a fully-coherent portion of the codebook, and where the UE is able to deliver full power on a single antenna port so that it meets maximum power requirements when not configured with UL MIMO.

Some fully-coherent UE implementations may require SRS to be transmitted periodically for phase calibration purposes, and if SRS is not transmitted frequently enough, it may not be possible to maintain coherence. Such UE implementations could benefit from nesting fully-coherent (FC) and non-coherent (NC) precoders. Also, UE implementations that use directive antennas may have greater benefit from non-coherent transmission, since it allows UEs to select an antenna with a particular direction, rather than combining different antennas with different beams and boresights, which can reduce array gain. These UEs would also benefit from nested FC+NC precoders.

UEs that support Rel-16 uplink full power transmission (UL FPTx) Mode 1 or similar operation are not required to maintain relative phase among antenna ports when operating in this mode. As discussed above, precoders with non-zero elements are used in UL FPTx Mode 1. It is possible to use such precoders for power saving operation as long as the Mode 1 precoders do not require transmission on all of the antenna ports. One example can be where a Rel-15 4 Tx precoder without zero valued elements in the precoding matrix is used in Rel-18 8 Tx operation, where the UE only transmits on the 4 ports corresponding to the 4 Tx precoder, and where the operation is non-coherent, that is, where the UE is not required to maintain coherence among the 4 ports. More generally, in such operation, the UE transmits without mutually controlled phase on a subset of its antenna ports according to a precoder that contains multiple non-zero elements for at least one layer of the transmission.

Therefore, in one embodiment using fully- and non-coherent transmission, a UE transmits on a subset of N antenna ports, where N is greater than 4, thus allowing it to save power by transmitting on a subset of N transmit chains. The UE can additionally transmit with mutually controlled phase on all its antenna ports, allowing it to deliver more power and to reduce interference. The UE receives signaling configuring the UE to transmit according to a set of precoders, the set comprising at most a first and a second type of precoder, wherein for an L layer transmission, the first type of precoders corresponds to transmitting on all of the N antenna ports with mutually controlled phase among all ports of a transmission of a physical channel. The second type of precoders corresponds to transmitting without controlled phase among all ports of a transmission of the physical channel and to transmitting on at least a subset of the N antenna ports. The UE receives an indication in a downlink control channel that identifies a precoder of the first or the second type and transmits the physical channel on the antenna ports according to the identified precoder.

Embodiments that support fully coherent precoding on all elements with only fully-coherent precoders for all rank transmissions may use the first type of precoder to support rank N transmission, and not require the second type of precoders to include non-coherent precoders that transmit on all antenna ports. However, implementations that do not support rank N transmission with fully coherent precoders may require the non-coherent precoders to support rank N. Therefore, in variation of the above embodiment, the second type of precoders additionally comprises a precoder that corresponds to transmitting on all the N antenna ports.

As discussed above, a single non-coherent precoder for each rank L could be included in the NC precoders to be nested with the FC precoders. Therefore, in variations of the above embodiments, each precoder of the second type of precoders corresponds to transmitting each layer of L layers on a corresponding single port of L ports, where there are at most N precoders of the second type.

Some approaches may transmit without mutually controlled phase on more than one port that corresponds to a layer. Therefore, in a variation of the above embodiments, the second type of precoder includes precoders that contain multiple non-zero elements for at least one layer of the transmission of the physical channel.

As discussed above and with respect to where partially coherent precoders are used below, it can be beneficial for non-coherent precoders to transmit on only a subset of the ports, that is, where the non-coherent precoders do not transmit at all on some antenna ports. Therefore, in a variation of the above embodiments, each precoder of the second type of precoders corresponds to transmitting only within an N2 port subset of the N antenna ports, the N2 port subset being the same for all of the second type of precoders, but the ports used by each precoder of the second type of precoders being different.

### Nesting Partially-Coherent (PC) Precoders and Fully-Coherent (FC) Precoders

The approach above for non-coherent precoders can be extended to partially coherent precoders. Partially coherent precoders may transmit a MIMO layer on more than one antenna, but less than all elements of an antenna array. For example, an 8 Tx UE supporting 4 antenna groups with partially coherent precoders might maintain coherence over pairs of its 8 elements. If a single pair of antenna elements corresponding to a partially coherent precoder is transmitted on, then the remaining 6 PAs for the remaining elements can be turned off, and similar power savings might be reached as when a rank 2 non-coherent precoder is used. A more general statement of this example would be to say that N1 of N (rather than 6 of 8) elements are not transmitted coherently with each other.

Adding a few more NC precoders can be easier than a few more PC precoders, since PC requires many more precoders than NC. This then can be an advantage compared to using FC+NC precoders as described in the embodiment above for use cases where it is desirable to minimize codebook size. However, it may be desirable to exploit coherence within a given number of active elements in the array to improve performance for a given amount of power saving, and where larger codebook sizes can be tolerated. In such cases, PC precoders can be used for power saving. When power saving is the primary reason for adding PC precoders and performance is secondary, methods of decreasing the number of PC precoders to be nested with FC precoders can be needed.

One way to reduce the number of PC precoders is to only include precoders that transmit on an N2 port subset of the antenna groups that can be supported by the array. For example, if 8 antenna ports of a fully coherent UE are mapped to 4 antenna port groups with 2 ports per group, a subset of the PC precoders for N_{g}=4 and rank r described above could be nested together with the FC precoders, where the PC precoder subset selects one or more port pairs for transmission, but where the subset does not allow transmission on N-N2 ports. Power can be saved in such a design, since the PC precoders allow transmission on fewer than all ports, unlike the FC precoders. However, if only the PC subset is used, the performance could be reduced if precoders using the disallowed ports could have provided better performance for given radio conditions and UE implementation. On the other hand, since how a UE maps antenna ports to Tx chains is generally left to UE implementation in NR, some UE implementations may determine a best subset of their antennas and Tx chains and map these to the antenna ports used in the PC codebook subset. In this way, the UE could achieve better performance from such PC precoder subsets. While it is particularly useful for reducing the number of PC precoders, transmitting on an N2 antenna port subset can also be beneficial to reduce the number of NC precoders.

A second way to reduce the number of PC precoders is to only include precoders with a limited number of phase differences among antenna ports. For example, if 8 antenna ports of a fully coherent UE are mapped to 4 antenna port groups with 2 ports per group, a subset of the PC precoders for N_g=4 and rank r described above could be nested together with the FC precoders, where the PC precoder subset selects one or more port pairs for transmission, and where fully coherent transmission is used between the two ports in the pairs, but coherence is not used across ports outside of a port pair. As can be seen in Tables 5 and 6, Rel-15 codebooks allow relative phases of 0, 90, 180, and 270 degrees among antenna ports. If Rel-18 8 Tx precoders were to use all four of these relative phases, codebook designs would require 4 phase combinations for each port pair combination supported by the codebook. The use of 4 phase combinations provided good performance in Rel-15 designs, but for Rel-18 8 Tx, since we target power reduction and have the FC precoders available, the PC subset could use fewer phase combinations. If instead combinations of 0 and 180 degrees are used, then two phase combinations for each port pair combination could be needed, which is half that required for the 4-phase combination case.

Either or both of the methods above could be used to design a nested power saving FC+PC codebook. Therefore, in another embodiment supporting partially coherent transmission, a UE again transmits on a subset of N antenna ports to save power and can additionally transmit with mutually controlled phase on all its antenna ports to deliver more power and to reduce interference. The UE receives signaling configuring the UE to transmit according to a set of precoders, the set comprising a first and a second type of precoder, wherein for an L layer transmission, the first type of precoder corresponds to transmitting on all of the N antenna ports with mutually controlled phase. However, the second type of precoder corresponds to transmitting without controlled phase among all ports on an N1 port subset of the N antenna ports and to transmitting the physical channel on a subset of the N antenna ports, and according to at least one of two constraints. For the first constraint, the precoders in the second type of precoders transmit only on an N2 antenna subset of the N antennas. For the second constraint, the phase difference between any two coherent ports of precoders in the second type of precoders is either 0 or 180 degrees. The UE receives an indication in a downlink control channel that identifies a precoder of the first or the second type and transmits the physical channel on the antenna ports according to the identified precoder.

As discussed above, a simple FC+NC nested codebook can be where a single NC precoder is nested with an FC codebook. The NC precoder could map a single antenna port to a Tx chain that can deliver full power in order to meet maximum power requirements when not configured with UL MIMO. It is also possible that the UE could transmit with full power on a subset of more than one port of the N antenna ports, where coherent transmission is used across the port subset and full power is achieved by combining the power of the ports in the subset using PC precoders in an FC+PC nested codebook. Therefore, an embodiment that is based on the embodiment that uses fully- and non-coherent transmission or on the embodiment that uses fully- and partially-coherent transmission further comprises indicating capability to transmit a MIMO layer coherently on all N antenna ports, wherein at least one antenna port can be transmitted with at most 1/N of the total power. The UE also indicates capability to transmit on a subset of the N antenna ports with at most the total power. In some such embodiments, the subset comprises a single antenna port on which the UE can transmit the total power.

In the following, the benefit of different nesting alternatives is investigated based on simulations: FC-only (with only fully-coherent precoders), FC+NC (where non-coherent are nested with fully-coherent precoders), and FC+PC+NC (where fully-, partially-, and non-coherent precoders are nested). Note that the maximum number of each FC (120 candidates obtained for (N₁, N₂)=(4, 1) with (O₁, O₂)=(1, 1)), PC (960 candidates obtained for N_{g}=2) and NC (255 candidates) precoders are considered. Here we use relatively large numbers of PC and NC precoders to see the potential for nesting them. Two cases are considered: where a ULA of co-boresighted antennas is used, and where two back-to-back panels are used. Here, it can be seen that for the ULA, there is essentially no difference among the mean and cell-edge user throughputs of all three nesting alternatives. On the other hand, for the directional antenna scenario with back-to-back panels, adding the NC precoders provides notable mean throughput gains (roughly 5%), which can mainly be attributed to the reduced inter-cell interference properties of the directional antennas used, but negligible mean throughput gains from adding the PC precoders. The relative cell-edge gains for adding NC (on top of FC) and PC (on top of FC+NC) are similar to each other, but fairly modest for cell-edge gains at most around 10%.

Accordingly, it can be observed that nesting different coherence precoders provides performance gain for multi-panel setups but not single panel setups. Adding a small number of non-coherent precoders may provide the most significant mean gain, while adding a large number of partially-coherent precoders can improve cell-edge but not mean throughput at a similar level to adding non-coherent precoders.

Given the good incremental gain from nesting NC precoders, methods to reduce their overhead even further may be considered. The reduction in the number of NC precoders to 32 can further allow possible nesting of the FC and NC precoders without increasing the DCI overhead, where the FC precoder size is pruned without the loss in the performance as discussed above. For example, for the case with (N₁, N₂)=(2,2), the 32 NC precoders can be added to 272 FC precoders obtained by restricting (O₁, O₂) to (1, 1) for rank 3-8 with (O₁, O₂) set to (2,2) for rank 1-2, while adding no additional signaling overhead. When comparing the performance of the pruned FC+NC precoders (with 272+32=304 candidates) with the FC+NC precoders with no pruning (with 512+255=767 candidates), it can be seen that the restricting of the nested FC+NC precoders to 304 candidates results in no performance loss. Similarly, the 32 NC precoders can be added to FC precoders for the case with (N1, N2)=(4, 1) result in 120 candidates with (O₁, O₂) set to (1,1), where additional pruning can be applied to the FC precoders similar to the pruning done to Rel-15 DL Type-I precoders to obtain Rel-15 4 Tx FC precoders. Further, the 32 NC precoders can be applied to pruned PC precoders, to obtain a nested PC+NC CB without an increase in the signaling overhead.

For the case with (N₁, N₂)=(4, 1) and (O₁, O₂) set to (1,1), when no additional pruning is desired for the FC precoders, the advantage of nesting with NC precoders without increasing the signaling overhead can be realized by reducing the NC precoders to 8 across all ranks, i.e., one NC precoder per rank. When comparing the performance of the pruned FC+NC precoders (with 120+8=128 candidates, requiring 7 bits) to the FC+NC precoders with no pruning (with 120+255=375 candidates, requiring 8 bits), it can be seen that the restricting of the nested FC+NC precoders to 128 candidates results in no performance loss, while not increasing the DCI signaling overhead.

Accordingly, it may be beneficial if a 8 Tx codebook subset design uses at least fully- and non-coherent precoders, targeting power saving, coherence fallback, and directional antennas with the non-coherent precoders.

### Full Power UL MIMO

Full power operation has greater implications in Rel-18 than in earlier releases simply because there are more possible PA power combinations, and due to the greater power, complexity, and size of 8 Tx arrays, and the variety of scenarios where 8 Tx UEs can be used. Full power modes have different requirements with respect to SRS resource configurations and affect codebook designs as well. In Rel-18, as regards support of full power operation by a partial/non-coherent 8 Tx UE configured with codebook-based transmission, Rel-16 UE capability definitions could be reused, i.e., UE Capability 1, 2 and 3. For full TX power transmission by UE Capability 2/3, at least PA architectures as illustrated by FIG. 8 and the table of FIG. 9 can be considered. This can be used for other UE Power Classes as well.

For an 8TX partial/non-coherent precoder, for full power codebook-based PUSCH transmissions, Rel-16 full power modes could be used as the starting point for the design. Support of all Rel-16 modes is however not required.

UEs, e.g., CPE (Customer Premises Equipment), FWA, vehicle, industrial, can vary substantially in terms of complexity, target use case, and antenna characteristics. Accordingly, as regards supported coherence types for 8 Tx, full, partial, and non-coherent precoders may be considered, different power classes be considered, and directional/omni-directional antennas at FR1 (as well as directional antennas at FR2) be considered. Accordingly, various UE PA architectures may need to be supported to enable the diverse applications where 8 Tx could be used.

One approach to defining what should be supported is to identify a minimum set of PA architecture assumptions such that if the assumptions do not match the assumptions, the deviation is acceptable in terms of complexity and performance tradeoffs. The highest performing/highest complexity cases are those with maximum PA power and full coherence, while the lowest performance/lowest complexity cases are minimum PA power and non-coherence. Common UE implementations have a primary Tx chain with full power PA and secondary Tx chains with lesser amounts of power, which guarantees full power prior to RRC configuration in UEs where it is not desirable to virtualize the Tx chains to one port. Therefore, a third configuration should have a full power path with reduced power on the remaining Tx chains.

PA powers per Tx chain to be considered with higher priority while designing full power modes for power class 3 are: [23 23 23 23 23 23 23 23 23], [23 14 14 14 14 14 14 14 14], and [14 14 14 14 14 14 14 14 14]. Given the above rationale, these configurations are a logical starting point. However, some middle ground may be missing where PA powers of 20 and 17 dBm are used, and so additional configurations could be helpful to enable more UE implementations.

One of the more complex aspects for Rel-16 is the indication of full power TPMIs. The benefit of such indication for 8 Tx operation should be carefully studied, since selection diversity gains diminish with increasing numbers of antenna ports. When focusing on homogeneous PA configurations for the additional cases, this should simplify the full power designs, and avoid excess specification impact as well as leave time to design more important aspects of 8 Tx operation.

It can be expected that 20 dBm PAs become more widely available in the near term, and so adding at least a [20 20 20 20 20 20 20 20] configuration could be useful. A similar configuration with 17 dBm could also be considered.

It can therefore be observed that PA powers of PC and PC/8, where PC is the power class, could be natural starting points to span the full range of complexity/performance tradeoffs. An intermediate case allowing one full power PA and one or two other cases with reduced PA power that can be supported by full/partial/non-coherent UEs may also desirable as a starting point for an 8 Tx implementations in Rel-18. Accordingly, in addition to the PA powers per Tx chain of [000000 0 0], [0 −9 −9 −9 −9 −9 −9 −9], and [−9 −9 −9 −9 −9 −9 −9 −9] dB relative to their power class, at least a [−3 −3 −3 −3 −3 −3 −3 −3] configuration could be considered for Rel-18 8 Tx full power UL MIMO operation. For full power Mode2 for an 8TX UE, one of the following could be selected as the CAP2-based architecture (Power class 3):
Alternative 1: P1=P2= . . . =P8=20 dBm,
Alternative 2: P1=P2= . . . =P8=17 dBm,
Alternative 3: Both Alternative 1 and Alternative 2.

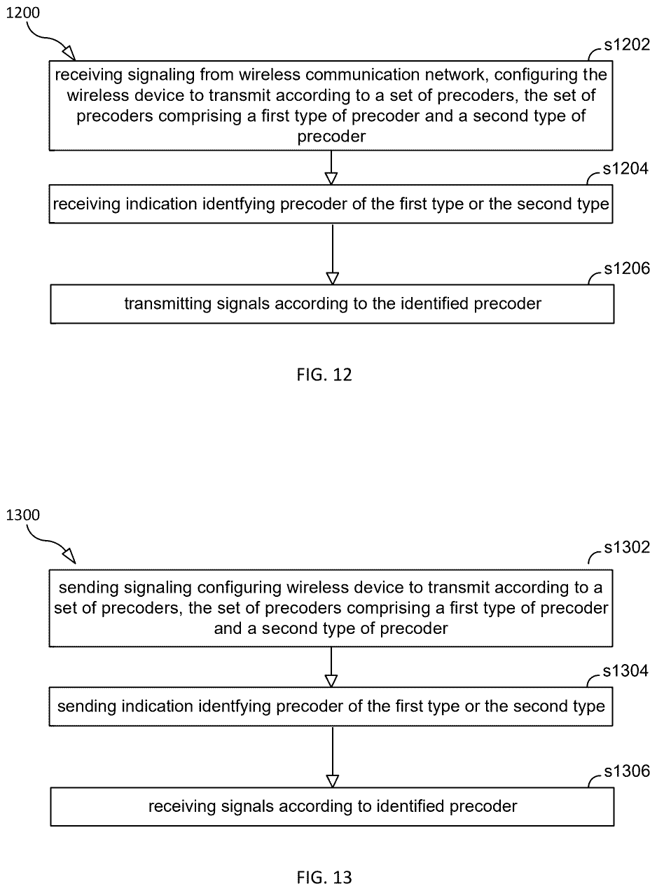

FIG. 12 shows a flowchart for illustrating a method performed by a wireless device, e.g., a UE, for implementing concepts as illustrated above. At least some of the steps of the method may be performed or controlled by processing circuitry of the wireless device, e.g., based on instructions stored in a memory of the wireless device and executed by the processing circuitry.

In the method of FIG. 12, the wireless device is assumed to be operative in a wireless communication network, e.g., a 3GPP network, and to have N antenna ports, with N>4.

At step s1202, the wireless device receives, from the wireless communication network, signaling configuring the wireless device to transmit according to a set of precoders. The set of precoders includes a first type of precoder and a second type of precoder. More specifically, the set of precoders may be limited to the first type of precoder and the second type of precoder and include no other types of precoders. In some scenarios, the set of precoders may consist of precoders of the first type and of the second type or may include at most the first type of precoder and the second type of precoder.

For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset.

In some scenarios, the second type of precoders may comprise a precoder that corresponds to transmitting on all the N antenna ports without controlled phase among all the ports.

In some scenarios, the second type of precoders may include at most N precoders, and wherein each precoder of the second type of precoders corresponds to transmitting each layer of L layers on a corresponding single port, wherein L<=N.

In some scenarios, each precoder of the second type of precoders may correspond to transmitting only within a subset of the N antenna ports, the subset of antenna ports being the same for all of the second type of precoders, but the ports used by each precoder of the second type of precoders being different.

In some scenarios, the second type of precoder includes precoders that contains multiple non-zero elements for at least one layer of the transmission of the physical channel.

In some scenarios, the wireless device may indicate to the network a capability of transmitting a layer with controlled phase on all N antenna ports, where at least one antenna port can transmit with at most 1/N of the total transmission power and indicating to the network a capability of transmitting on a subset of the N antenna ports with at most the total transmission power.

At step s1204, the wireless device receives, from the wireless communication network, an indication that identifies a precoder of the first or the second type.

At step s1206, the wireless device transmits signals on the antenna ports according to the precoder identified by the indication of step s1204.

FIG. 13 shows a flowchart for illustrating a method performed by a network node, e.g., a radio access node or base station of a wireless communication network, e.g., a 3GPP network, for implementing concepts as illustrated above. At least some of the steps of the method may be performed or controlled by processing circuitry of the network node, e.g., based on instructions stored in a memory of the wireless device and executed by the processing circuitry.

In the method of FIG. 13, it is assumed that the network node receives transmissions from a wireless device which has N antenna ports, with N>4.

At step s1302, the network node sends, to the wireless device, signaling configuring the wireless device to transmit according to a set of precoders. The set of precoders includes a first type of precoder and a second type of precoder. More specifically, the set of precoders may be limited to the first type of precoder and the second type of precoder and include no other types of precoders. In some scenarios, the set of precoders may consist of precoders of the first type and of the second type or may include at most the first type of precoder and the second type of precoder.

For a transmission comprising L layers the first type of precoder corresponds to transmitting on all of the N antenna ports with mutually controlled phase among all the ports, and the second type of precoder corresponds to transmitting on at least a subset of the N antenna ports and to transmitting without controlled phase among all the antenna ports in the subset.

In some scenarios, the second type of precoders may comprise a precoder that corresponds to transmitting on all the N antenna ports without controlled phase among all the ports.

In some scenarios, the second type of precoders may include at most N precoders, and wherein each precoder of the second type of precoders corresponds to transmitting each layer of L layers on a corresponding single port, wherein L<=N.

In some scenarios, each precoder of the second type of precoders may correspond to transmitting only within a subset of the N antenna ports, the subset of antenna ports being the same for all of the second type of precoders, but the ports used by each precoder of the second type of precoders being different.

In some scenarios, the second type of precoder includes precoders that contains multiple non-zero elements for at least one layer of the transmission of the physical channel.

In some scenarios, the network node may receive, from the wireless device, an indication of a capability of transmitting a layer with controlled phase on all N antenna ports, where at least one antenna port can transmit with at most 1/N of the total transmission power and an indication of a capability of transmitting on a subset of the N antenna ports with at most the total transmission power.

At step s1304, the network node sends, to the wireless device, an indication that identifies a precoder of the first or the second type. In some scenarios, prior to sending an indication that identifies a precoder of the first or the second type, the network node may receive one or more reference signal from the wireless device. Based on the one or more reference signals, the network node may determine a precoder of the first or the second type for the wireless device to use.

At step s1306, the receives signals transmitted by the wireless device on the antenna ports according to the precoder identified by the indication of step s1304.

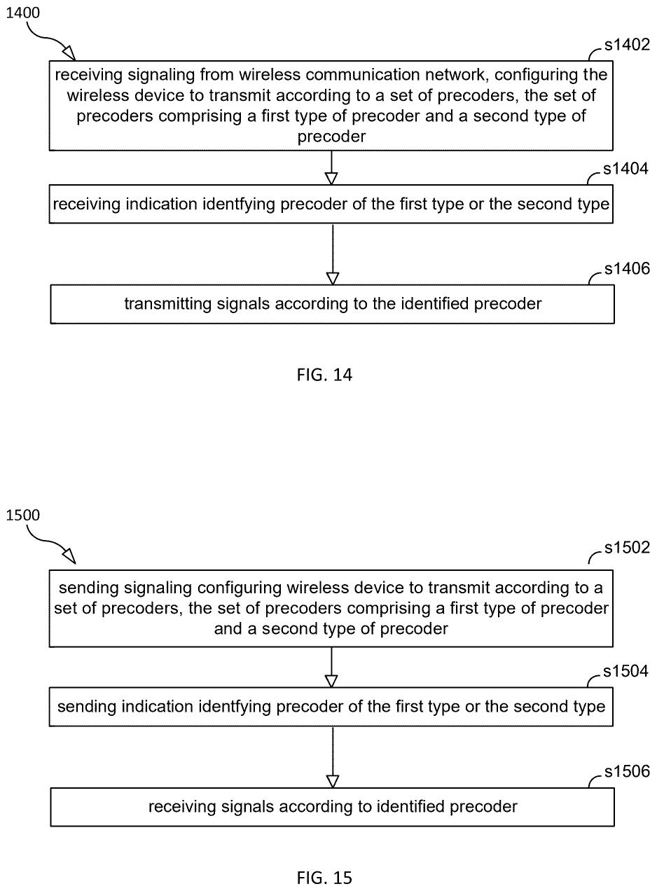

FIG. 14 shows a flowchart for illustrating a method performed by a wireless device, e.g., a UE, for implementing concepts as illustrated above. At least some of the steps of the method may be performed or controlled by processing circuitry of the wireless device, e.g., based on instructions stored in a memory of the wireless device and executed by the processing circuitry.

In the method of FIG. 14, the wireless device is assumed to be operative in a wireless communication network, e.g., a 3GPP network, and to have N antenna ports.

At step s1402, the wireless device receives, from the wireless communication network, signaling configuring the wireless device to transmit according to a set of precoders. The set of precoders includes a first type of precoder and a second type of precoder. The set of precoders may be limited to the first type of precoder and the second type of precoder and include no other types of precoders. In some scenarios, the set of precoders may consist of precoders of the first type and of the second type or may include at most the first type of precoder and the second type of precoder.

For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting the physical channel on antenna ports of different groups, under at least one of the following constraints:
the precoders in the second type of precoders transmit on a total number of antenna ports fewer than N, and
the precoders in the second type of precoders transmit with a phase difference between antenna ports within a group of either 0 or 180 degrees.

In some scenarios, the second type of precoders may comprise a precoder that corresponds to transmitting on all the N antenna ports without controlled phase among all the ports.

In some scenarios, the second type of precoders may include at most N precoders, and wherein each precoder of the second type of precoders corresponds to transmitting each layer of L layers on a corresponding single port, wherein L<=N.

In some scenarios, each precoder of the second type of precoders may correspond to transmitting only within a subset of the N antenna ports, the subset of antenna ports being the same for all of the second type of precoders, but the ports used by each precoder of the second type of precoders being different.

In some scenarios, the second type of precoder includes precoders that contains multiple non-zero elements for at least one layer of the transmission of the physical channel.

In some scenarios, the wireless device may indicate to the network a capability of transmitting a layer with controlled phase on all N antenna ports, where at least one antenna port can transmit with at most 1/N of the total transmission power and indicating to the network a capability of transmitting on a subset of the N antenna ports with at most the total transmission power.

At step s1404, the wireless device receives, from the wireless communication network, an indication that identifies a precoder of the first or the second type.

At step s1406, the wireless device transmits signals on the antenna ports according to the precoder identified by the indication of step s1404.

FIG. 15 shows a flowchart for illustrating a method performed by a network node, e.g., a radio access node or base station of a wireless communication network, e.g., a 3GPP network, for implementing concepts as illustrated above. At least some of the steps of the method may be performed or controlled by processing circuitry of the network node, e.g., based on instructions stored in a memory of the wireless device and executed by the processing circuitry.

In the method of FIG. 15, it is assumed that the network node receives transmissions from a wireless device which has N antenna ports.

At step s1502, the network node sends, to the wireless device, signaling configuring the wireless device to transmit according to a set of precoders. The set of precoders includes a first type of precoder and a second type of precoder. The set of precoders may be limited to the first type of precoder and the second type of precoder and include no other types of precoders. In some scenarios, the set of precoders may consist of precoders of the first type and of the second type or may include at most the first type of precoder and the second type of precoder.

For an L layer transmission, the first type of precoder corresponds to transmitting on all of the N antenna ports with mutually controlled phase among all the ports, and the second type of precoder corresponds to transmitting with controlled phase among all ports in each of one or more groups of the N antenna ports and to transmitting the physical channel on antenna ports of different groups, under at least one of the following constraints:
the precoders in the second type of precoders transmit on a total number of antenna ports fewer than N, and
the precoders in the second type of precoders transmit with a phase difference between antenna ports within a group of either 0 or 180 degrees.

In some scenarios, the second type of precoders may include at most N precoders, and wherein each precoder of the second type of precoders corresponds to transmitting each layer of L layers on a corresponding single port, wherein L<=N.

In some scenarios, each precoder of the second type of precoders may correspond to transmitting only within a subset of the N antenna ports, the subset of antenna ports being the same for all of the second type of precoders, but the ports used by each precoder of the second type of precoders being different.

In some scenarios, the second type of precoder includes precoders that contains multiple non-zero elements for at least one layer of the transmission of the physical channel.

In some scenarios, the network node may receive, from the wireless device, an indication of a capability of transmitting a layer with controlled phase on all N antenna ports, where at least one antenna port can transmit with at most 1/N of the total transmission power and an indication of a capability of transmitting on a subset of the N antenna ports with at most the total transmission power.

At step s1504, the network node sends, to the wireless device, an indication that identifies a precoder of the first or the second type. In some scenarios, prior to sending an indication that identifies a precoder of the first or the second type, the network node may receive one or more reference signal from the wireless device. Based on the one or more reference signals, the network node may determine a precoder of the first or the second type for the wireless device to use.

At step s1506, the receives signals transmitted by the wireless device on the antenna ports according to the precoder identified by the indication of step s1504.

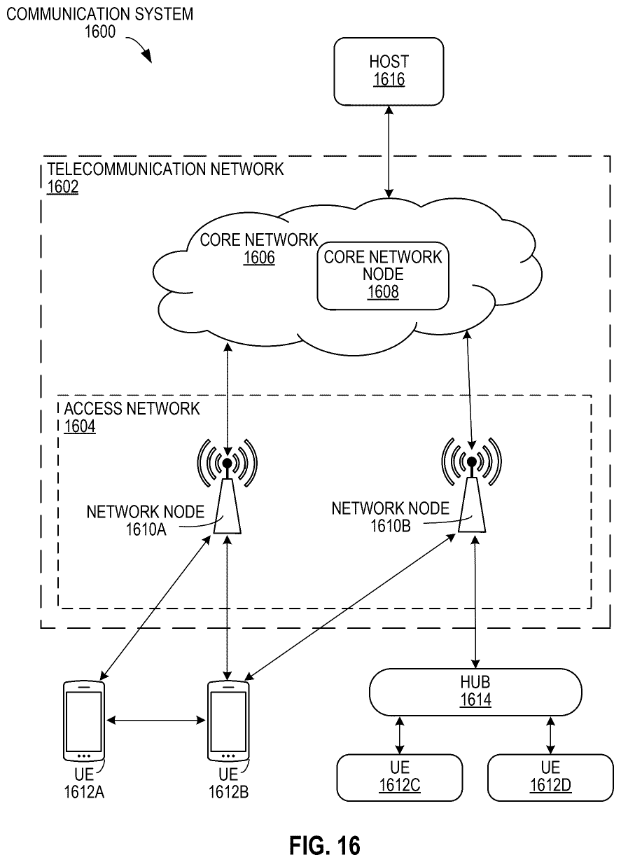

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3rd Generation Partnership Project (3GPP) access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

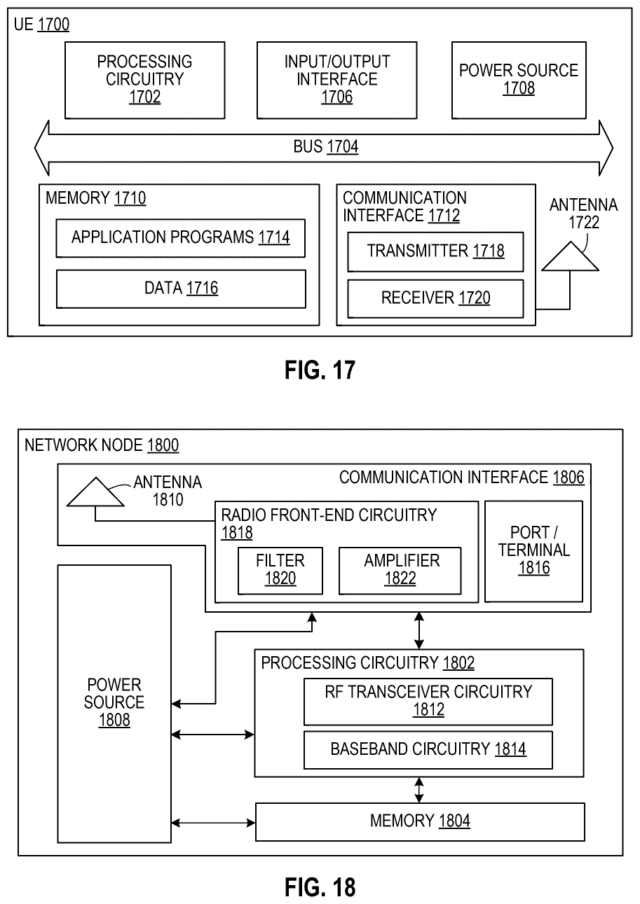

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

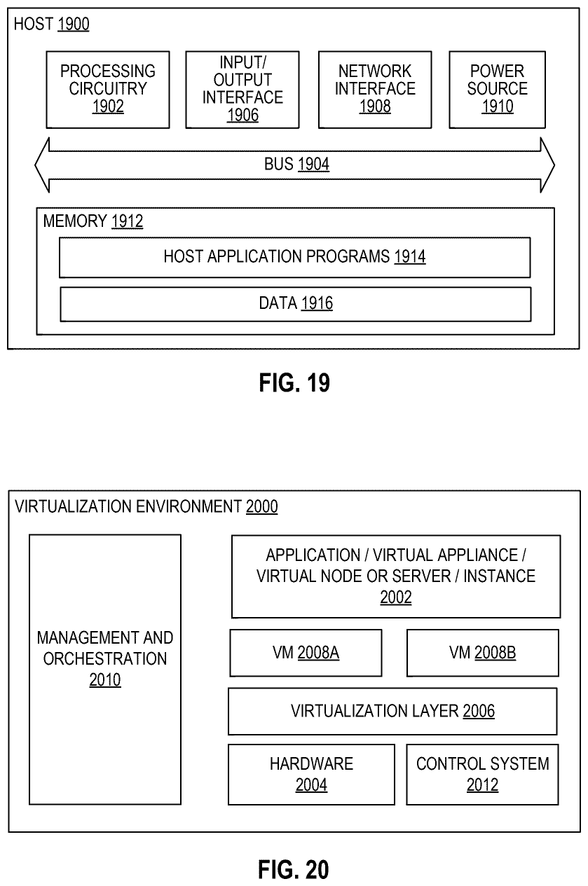

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

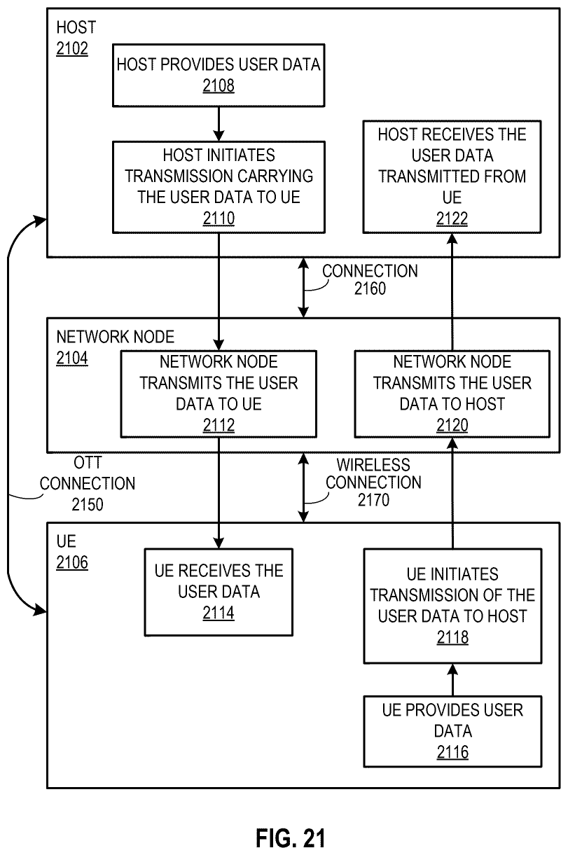

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method, performed by a wireless device operative in a wireless communication network and having N antenna ports, wherein N>4, of transmitting on all the N antenna ports with controlled phase or transmitting on a subset of N antenna ports without controlled phase, the method comprising:
receiving, from the network, signaling configuring the wireless device to transmit according to a set of precoders, the set of precoders comprising at most a first type of precoder and a second type of precoder, wherein for a transmission comprising L layers,
   the first type of precoder corresponds to transmitting on all of the N antenna ports with mutually controlled phase among all the ports, and
   the second type of precoder corresponds to transmitting on at least a subset of the N antenna ports and to transmitting without controlled phase among all the antenna ports in the subset;
receiving, from the network, an indication that identifies a precoder of the first or the second type; and
transmitting signals on the antenna ports according to the identified precoder.

2. The method of embodiment 1, wherein the second type of precoder additionally comprises a precoder that corresponds to transmitting on all the N antenna ports without controlled phase among all the ports.

3. The method of embodiments 1 or 2, wherein the second type of precoders includes at most N precoders, and wherein each precoder of the second type of precoders corresponds to transmitting each layer of L layers on a corresponding single port, wherein L<=N.

4. The method of any of embodiments 1-3, wherein each precoder of the second type of precoders corresponds to transmitting only within a subset of the N antenna ports, the subset of antenna ports being the same for all of the second type of precoders, but the ports used by each precoder of the second type of precoders being different.

5. The method of any of embodiments 1-4, wherein the second type of precoder includes precoders that contains multiple non-zero elements for at least one layer of the transmission of the physical channel.

6. The method of any of embodiments 1-5, further comprising:
indicating to the network a capability of transmitting a layer with controlled phase on all N antenna ports, where at least one antenna port can transmit with at most 1/N of the total transmission power; and
indicating to the network a capability of transmitting on a subset of the N antenna ports with at most the total transmission power.

7. A method, performed by a wireless device operative in a wireless communication network and having N antenna ports, the method comprising:
receiving signaling configuring the wireless device to transmit according to a set of precoders, the set comprising a first type of precoder and a second type of precoder, wherein for an L layer transmission,
   the first type of precoder corresponds to transmitting on all of the N antenna ports with mutually controlled phase among all the ports, and
   the second type of precoder corresponds to transmitting with controlled phase among all ports in each of one or more groups of the N antenna ports and to transmitting the physical channel on antenna ports of different groups, under at least one of the following constraints:
      the precoders in the second type of precoders transmit on a total number of antenna ports fewer than N, and
      the precoders in the second type of precoders transmit with a phase difference between antenna ports within a group of either 0 or 180 degrees;
receiving an indication from the network identifying a precoder of the first or the second type; and
transmitting signals on antenna ports according to the identified precoder.

8. The method of embodiment 7, further comprising:
indicating to the network a capability of transmitting a layer with controlled phase on all N antenna ports, where at least one antenna port can transmit with at most 1/N of the total transmission power; and
indicating to the network a capability of transmitting on a subset of the N antenna ports with at most the total transmission power.

9. The method of any of the previous embodiments, further comprising:
providing user data; and
forwarding the user data to a host via the transmission to the network node.

### Group B Embodiments

10. A method, performed by a network node operative in a wireless communication network, of receiving transmissions from a wireless device having N antenna ports, wherein the wireless device transmits on all the N antenna ports with controlled phase or transmits on a subset of N antenna ports without controlled phase, the method comprising:
sending, to the wireless device, signaling configuring the wireless device to transmit according to a set of precoders, the set of precoders comprising at most a first type of precoder and a second type of precoder, wherein for a transmission comprising L layers,
   the first type of precoder corresponds to the wireless device transmitting on all of the N antenna ports with mutually controlled phase among all the ports, and
   the second type of precoder corresponds to the wireless device transmitting on at least a subset of the N antenna ports and to transmitting without controlled phase among all the antenna ports in the subset;
sending, to the wireless device, an indication that identifies a precoder of the first or the second type; and
receiving, from the wireless device, signals transmitted on the antenna ports according to the identified precoder.

11. The method of embodiment 10, wherein the second type of precoder additionally comprises a precoder that corresponds to transmitting on all the N antenna ports without controlled phase among all the ports.

12. The method of embodiments 10 or 11, wherein the second type of precoders includes at most N precoders, and wherein each precoder of the second type of precoders corresponds to transmitting each layer of L layers on a corresponding single port, wherein L<=N.

13. The method of any of embodiments 10-12, wherein each precoder of the second type of precoders corresponds to transmitting only within a subset of the N antenna ports, the subset of antenna ports being the same for all of the second type of precoders, but the ports used by each precoder of the second type of precoders being different.

14. The method of any of embodiments 10-13, wherein the second type of precoder includes precoders that contains multiple non-zero elements for at least one layer of the transmission of the physical channel.

15. The method of any of embodiments 10-14, further comprising:
receiving, from the wireless device, an indication of a capability of transmitting a layer with controlled phase on all N antenna ports, where at least one antenna port can transmit with at most 1/N of the total transmission power; and
receiving, from the wireless device, an indication of a capability of transmitting on a subset of the N antenna ports with at most the total transmission power.

16. The method of embodiment 10, further comprising, prior to sending an indication that identifies a precoder of the first or the second type:
receiving, from the wireless device, one or more reference signals; and
based on the one or more reference signals, determining a precoder of the first or the second type for the wireless device to use.

17. A method, performed by a network node operative in a wireless communication network, of receiving transmissions from a wireless device having N antenna ports, the method comprising:
sending, to the wireless device, signaling configuring the wireless device to transmit according to a set of precoders, the set comprising a first type of precoder and a second type of precoder, wherein for an L layer transmission,
   the first type of precoder corresponds to transmitting on all of the N antenna ports with mutually controlled phase among all the ports, and
   the second type of precoder corresponds to transmitting with controlled phase among all ports in each of one or more groups of the N antenna ports and to transmitting the physical channel on antenna ports of different groups, under at least one of the following constraints:
      the precoders in the second type of precoders transmit on a total number of antenna ports fewer than N, and
      the precoders in the second type of precoders transmit with a phase difference between antenna ports within a group of either 0 or 180 degrees;
sending, to the wireless device, an indication from the network identifying a precoder of the first or the second type; and
receiving, from the wireless device, signals transmitted by the wireless device on antenna ports according to the identified precoder.

18. The method of embodiment 17, further comprising:
receiving, from the wireless device, an indication of a capability of transmitting a layer with controlled phase on all N antenna ports, where at least one antenna port can transmit with at most 1/N of the total transmission power; and
receiving, from the wireless device, an indication of a capability of transmitting on a subset of the N antenna ports with at most the total transmission power.

19. The method of any of embodiments 10-18, further comprising:
obtaining user data; and
forwarding the user data to a host or a user equipment.

### Group C Embodiments

20. A user equipment for power savings when transmitting uplink Multiple Input Multiple Output (MIMO) signaling, comprising:
processing circuitry configured to perform any of the steps of any of the Group A embodiments; and
power supply circuitry configured to supply power to the processing circuitry.

21. A network node for receiving uplink Multiple Input Multiple Output (MIMO) signaling from user equipment, the network node comprising:
processing circuitry configured to perform any of the steps of any of the Group B embodiments;
power supply circuitry configured to supply power to the processing circuitry.

22. A user equipment (UE) for power savings when transmitting uplink Multiple Input Multiple Output (MIMO) signaling, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

23. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

24. The host of the previous embodiment, wherein the cellular network further includes a network node configured to communicate with the UE to transmit the user data to the UE from the host.

25. The host of the previous 2 embodiments, wherein:
the processing circuitry of the host is configured to execute a host application, thereby providing the user data; and
the host application is configured to interact with a client application executing on the UE, the client application being associated with the host application.

26. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

27. The method of the previous embodiment, further comprising:
at the host, executing a host application associated with a client application executing on the UE to receive the user data from the UE.

28. The method of the previous embodiment, further comprising:
at the host, transmitting input data to the client application executing on the UE, the input data being provided by executing the host application,
wherein the user data is provided by the client application in response to the input data from the host application.

29. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

30. The host of the previous embodiment, wherein the cellular network further includes a network node configured to communicate with the UE to transmit the user data from the UE to the host.

31. The host of the previous two embodiments, wherein:
the processing circuitry of the host is configured to execute a host application, thereby providing the user data; and
the host application is configured to interact with a client application executing on the UE, the client application being associated with the host application.

32. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

33. The method of the previous embodiment, further comprising:
at the host, executing a host application associated with a client application executing on the UE to receive the user data from the UE.

34. The method of the previous embodiment, further comprising:
at the host, transmitting input data to the client application executing on the UE, the input data being provided by executing the host application,
wherein the user data is provided by the client application in response to the input data from the host application.

35. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

36. The host of the previous embodiment, wherein:
the processing circuitry of the host is configured to execute a host application that provides the user data; and
the UE comprises processing circuitry configured to execute a client application associated with the host application to receive the transmission of user data from the host.

37. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

38. The method of the previous embodiment, further comprising, at the network node, transmitting the user data provided by the host for the UE.

39. The method of any of the previous two embodiments, wherein the user data is provided at the host by executing a host application that interacts with a client application executing on the UE, the client application being associated with the host application.

40. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

41. The communication system of the previous embodiment, further comprising:
the network node; and/or
the user equipment.

42. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

43. The host of the previous two embodiments, wherein:
the processing circuitry of the host is configured to execute a host application, thereby providing the user data; and
the host application is configured to interact with a client application executing on the UE, the client application being associated with the host application.

44. The host of the any of the previous two embodiments, wherein the initiating receipt of the user data comprises requesting the user data.

45. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

45. The method of the previous embodiment, further comprising at the network node, transmitting the received user data to the host.

1. A method, performed by a wireless device operative in a wireless communication network and having N antenna ports, wherein N>4, the method comprising:
receiving, from the wireless communication network, signaling configuring the wireless device to transmit according to a set of precoders, the set of precoders comprising a first type of precoder and a second type of precoder, wherein for a transmission comprising L layers,
the first type of precoder corresponds to transmitting on all of the N antenna ports with mutually controlled phase among all the ports, and
the second type of precoder corresponds to transmitting on at least a subset of the N antenna ports and to transmitting without controlled phase among all the antenna ports in the subset;
receiving, from the wireless communication network, an indication that identifies a precoder of the first or the second type; and
transmitting signals on the antenna ports according to the identified precoder.

2. The method of claim 1, wherein the second type of precoder additionally comprises a precoder that corresponds to transmitting on all the N antenna ports without controlled phase among all the ports.

3. The method of claim 1, wherein the second type of precoders includes at most N precoders, and wherein each precoder of the second type of precoders corresponds to transmitting each layer of L layers on a corresponding single port, wherein L<=N.

4. The method of claim 1, wherein each precoder of the second type of precoders corresponds to transmitting only within a subset of the N antenna ports, the subset of antenna ports being the same for all of the second type of precoders, but the ports used by each precoder of the second type of precoders being different.

5. The method of claim 1, wherein the second type of precoder includes precoders that contains multiple non-zero elements for at least one layer of the transmission.

6. The method of claim 1, further comprising:
indicating to the network a capability of transmitting a layer with controlled phase on all N antenna ports, where at least one antenna port can transmit with at most 1/N of the total transmission power; and
indicating to the network a capability of transmitting on a subset of the N antenna ports with at most the total transmission power.

7. A method, performed by a wireless device operative in a wireless communication network and having N antenna ports, the method comprising:
receiving signaling configuring the wireless device to transmit according to a set of precoders, the set comprising a first type of precoder and a second type of precoder, wherein for an L layer transmission,
the first type of precoder corresponds to transmitting on all of the N antenna ports with mutually controlled phase among all the ports, and
the second type of precoder corresponds to transmitting with controlled phase among all ports in each of one or more groups of the N antenna ports and to transmitting on antenna ports of different groups, under at least one of the following constraints:
the precoders in the second type of precoders transmit on a total number of antenna ports fewer than N, and
the precoders in the second type of precoders transmit with a phase difference between antenna ports within a group of either 0 or 180 degrees;
receiving an indication from the wireless communication network identifying a precoder of the first or the second type; and
transmitting signals on antenna ports according to the identified precoder.

8. The method of claim 7, further comprising:
indicating to the wireless communication network a capability of transmitting a layer with controlled phase on all N antenna ports, where at least one antenna port can transmit with at most 1/N of the total transmission power; and
indicating to the network a capability of transmitting on a subset of the N antenna ports with at most the total transmission power.

9. The method of claim 7, wherein the second type of precoder includes precoders that contains multiple non-zero elements for at least one layer of the transmission.

10. A method, performed by a network node operative in a wireless communication network, the method comprising:
sending, to a wireless device having N antenna ports, wherein N>4, signaling configuring the wireless device to transmit according to a set of precoders, the set of precoders comprising a first type of precoder and a second type of precoder, wherein for a transmission comprising L layers,
the first type of precoder corresponds to the wireless device transmitting on all of the N antenna ports with mutually controlled phase among all the ports, and
the second type of precoder corresponds to the wireless device transmitting on at least a subset of the N antenna ports and to transmitting without controlled phase among all the antenna ports in the subset;
sending, to the wireless device, an indication that identifies a precoder of the first or the second type; and
receiving, from the wireless device, signals transmitted on the antenna ports according to the identified precoder.

11. The method of claim 10, wherein the second type of precoder additionally comprises a precoder that corresponds to transmitting on all the N antenna ports without controlled phase among all the ports.

12. The method of claim 10, wherein the second type of precoders includes at most N precoders, and wherein each precoder of the second type of precoders corresponds to transmitting each layer of L layers on a corresponding single port, wherein L<=N.

13. The method of claim 10, wherein each precoder of the second type of precoders corresponds to transmitting only within a subset of the N antenna ports, the subset of antenna ports being the same for all of the second type of precoders, but the ports used by each precoder of the second type of precoders being different.

14. The method of claim 10, wherein the second type of precoder includes precoders that contains multiple non-zero elements for at least one layer of the transmission.

15. The method of claim 1, further comprising:
receiving, from the wireless device, an indication of a capability of transmitting a layer with controlled phase on all N antenna ports, where at least one antenna port can transmit with at most 1/N of the total transmission power; and
receiving, from the wireless device, an indication of a capability of transmitting on a subset of the N antenna ports with at most the total transmission power.

16. The method of claim 10, further comprising, prior to sending an indication that identifies a precoder of the first or the second type:
receiving, from the wireless device, one or more reference signals; and
based on the one or more reference signals, determining a precoder of the first or the second type for the wireless device to use.

17-33. (canceled)
